(19) United States
(12) Patent Application Publication
(10) Pub. No.: US 2018/0062852 A1
(43) Pub. Date: Mar. 1, 2018

(54) SYSTEMS AND METHODS FOR SECURE COLLABORATION WITH PRECISION ACCESS MANAGEMENT

(71) Applicant: Adin Reicin Schmahmann, Cambridge, MA (US)

(72) Inventor: Adin Reicin Schmahmann, Cambridge, MA (US)

(21) Appl. No.: 15/676,533

(22) Filed: Aug. 14, 2017

Related U.S. Application Data
(63) Continuation of application No. PCT/US2016/017983, filed on Feb. 15, 2016.
(60) Provisional application No. 62/116,553, filed on Feb. 15, 2015.

(51) Int. Cl. H04L 9/32; H04L 9/14; H04L 9/30

(52) U.S. Cl. CPC H04L 9/3247; H04L 9/30; H04L 9/14

(57) ABSTRACT

Systems and methods for secure collaboration enable precise access management. Collaborator permissions are modified in the same manner as a collaborative document. Use of asymmetric keys to encrypt private portion of the collaborative document enable write-only permissions. Permissions may be specified at any granularity allowed by operational analysis. In some implementations, systems and methods detect a change event for an electronic document, and package the change event as an encrypted digital representation of the change event and a cryptographic signature associated with a user identifier. Clients determine whether to accept the change event based on the authenticity of the signature and the permissions allocated to the user identifier.

### RELATED APPLICATIONS

The present application claims priority to and is a continuation of International Application No. PCT/US2016/17983, filed Feb. 15, 2016, titled “Systems and Methods for Secure Collaboration with Precision Access Management”, which in turn claims priority to U.S. Provisional Application Ser. No. 62/116,553, filed Feb. 15, 2015, titled “SURGE—The Secure Cloud Storage and Collaboration Framework,” which are incorporated herein by reference in their entirety.

### BACKGROUND

Collaborative editing enables multiple participants to read and modify a shared electronic document, presentation, file, work product, research, or any other form of data set that collaborators might view, edit, or otherwise use in an electronic form. For simplicity, the various possible types of data sets are collectively referred to herein generally, and without restriction, as a “document.” Participants edit the shared document and collaborators receive indication of the modification. The indication may be shared as a new copy of the document or as information representing a change to the document. The information may be shared between collaborator devices over a network.

Generally, information may be transmitted from one end device to another end device over a collection of links and network devices forming one or more computer networks. The information is typically represented as bits grouped into packets, and the packets are passed from one network device to another via the links to propagate the information through the computer networks. The network devices may include, for example, hubs, switches, routers, firewalls, and various types of servers. The network devices communicate using a variety of protocols. These protocols can usually be characterized, for example, using the Open Systems Interconnection (“OSI”) 7-layer model.

In some instances, a device in the network will store the information, e.g., in a buffer or in a log, for later use. Some network communications follow protocols that expect the information to reside at a server for some minimum open-ended length of time. For example, an electronic mail (“e-mail”) message may be sent, e.g., using the Simple Mail Transfer Protocol (“SMTP”), from a source device to a recipient's e-mail server. The recipient's device can then fetch the e-mail message from the e-mail server at a later time, e.g., using the Internet Message Access Protocol (“IMAP”). Notably, the e-mail message resides on the e-mail server until it is fetched and may continue to be stored there long after the recipient has finished with it. As a result, anyone with access to the e-mail server can read, process, consume, or otherwise make use of the information represented in the e-mail message.

One current trend in network computing, sometimes referred to as “cloud computing,” is to lease network resources from third-party hosts. The resources may include computing resources for executing custom software, computing services providing specific functionality such as databases or load balancing, and storage space for private or shared data storage. Examples of cloud computing service providers include, for example, Amazon.com, Inc. (e.g., Amazon Web Services), Rackspace Hosting, Inc. (e.g., Rackspace Cloud), Google Inc. (e.g. Google Compute Engine), and Microsoft Corp. (e.g., Windows Azure). Cloud computing service providers may provide multi-tenant clouds, or may provide dedicated infrastructure to a single tenant. However, parties storing unencrypted information with such third-party hosts are required to trust those hosts. Even trusted hosts may not always be able to protect customer data from being accessed by host employees, unauthorized intruders, and the requirements of governments and law enforcement agencies.

### SUMMARY

Aspects and embodiments of the present disclosure are directed to systems and methods for secure collaboration with precision access management. In some implementations, secure collaboration for a first document is facilitated by secure collaboration on a second document. For example, as described herein, a collaborative document can be used to implement secure messaging, private asymmetric encryption key sharing, anonymous or pseudo-anonymous sharing, straw account management, and group account management.

It is desirable to restrict access to information transmitted through a network and stored at devices in the network, particularly at devices that are under third-party control, while still providing access to one or more authorized parties. Access to information that has been encrypted is generally restricted to parties in possession of the proper decryption key or keys. Information stored in an encrypted manner on a server, even a third-party server, cannot be accessed without either possession of the proper decryption key or keys or breaking the encryption algorithm. For purposes of this disclosure, it is assumed that breaking certain encryption algorithms is impossible or impracticable. Accordingly, encrypted information may be transmitted through a network and stored on servers in a manner that prevents unauthorized access to that information. In addition to privacy, cryptographic signatures may be used to ensure integrity of the information. For example, cryptographic signatures may be used to add veracity to a claim that information originated with a particular signer.

Storing and collaborating on data using third-party network resources, e.g., “the cloud,” can provide many advantages over other approaches. However, because multi-party collaboration requires sharing information between two or more parties, each participant needs access to the information shared. To do so securely, without providing outside parties such as a cloud host with that same access, can be achieved using encryption. For example, Ariel J. Feldman, et. al., published “SPORC: Group Collaboration using Untrusted Cloud Resources,” in 2010. SPORC works by securely storing a log of the operations (i.e. changes) to a collaborative data object. However, among other short-comings, SPORC cannot accommodate precision access management. In SPORC a user can only “be given one of three privilege levels: reader, which entitles the user to decrypt the document but not to submit new operations; editor, which entitles the user to read the document and to submit new operations (except those that change the ACL); and administrator, which grants the user full access, including the ability to invite new users and remove existing users.” (SPORC, § 4.)

Accordingly, described herein are systems and methods for secure collaboration with precision access management.

In at least one aspect, the disclosure pertains to non-transitory computer-readable memory storing computer-readable instructions. The instructions, when executed by a computing processor, cause the computing processor to detect, for an electronic document, a change event associated with a user identifier. The instructions, when executed by the computing processor, cause the computing processor to identify, for the electronic document, a document-specific asymmetric encryption key, and identify, for the user identifier, a user-specific signature key. The instructions, when executed by a computing processor, cause the computing processor to generate a digital representation of the change event containing at least a context identifier for a state of the electronic document prior to the change event and an instruction for effecting the change event, and to generate, using the user-specific signature key, a cryptographic signature of the digital representation of the change event. The instructions, when executed by a computing processor, cause the computing processor to encrypt, using the document-specific asymmetric encryption key, the digital representation of the change event. The instructions, when executed by a computing processor, cause the computing processor to generate an operation capsule containing the encrypted digital representation of the change event and the cryptographic signature.

In at least one aspect, the disclosure pertains to non-transitory computer-readable memory storing computer-readable instructions. The instructions, when executed by a computing processor, cause the computing processor to detect, for an electronic document, a permissions change event associated with a user identifier. The instructions, when executed by a computing processor, cause the computing processor to identify, for the user identifier, a user-specific signature key. The instructions, when executed by a computing processor, cause the computing processor to generate a digital representation of the change event containing a context identifier for a state of the electronic document prior to the permissions change event and an instruction for effecting the change event. The instructions, when executed by a computing processor, cause the computing processor to generate, using the user-specific signature key, a cryptographic signature of the digital representation of the permissions change event. The instructions, when executed by a computing processor, cause the computing processor to generate an operation capsule containing the digital representation of the permissions change event and the cryptographic signature. In some implementations, the digital representation of the permissions change event is included in the operation capsule in an unencrypted form.

In at least one aspect, the disclosure pertains to non-transitory computer-readable memory storing computer-readable instructions. The instructions, when executed by a computing processor, cause the computing processor to receive, for an electronic document, a collaborator operation capsule containing a collaborator identifier, a digital representation of a collaborator change event, and a collaborator signature for the digital representation of the collaborator change event. The instructions, when executed by a computing processor, cause the computing processor to authenticate the collaborator signature using a collaborator-specific signature verification key and to verify, in a set of permissions associated with the electronic document, that the collaborator identifier has authorization to perform the collaborator change event. The instructions, when executed by a computing processor, cause the computing processor to apply the change event to the electronic document. In some implementations, the change event is only applied to the electronic document responsive to successfully authenticating the collaborator signature and verifying that the collaborator identifier has authorization to perform the collaborator change event. In some implementations, the change event is encrypted with a document-specific asymmetric encryption key and the method includes locating an encrypted copy of a corresponding document-specific asymmetric decryption key and decrypting the encrypted copy of the corresponding document-specific asymmetric decryption key using a user-specific asymmetric decryption key.

In at least one aspect, the disclosure pertains to a method of secure collaboration. The method includes detecting, for an electronic document, a change event associated with a user identifier. The method includes identifying, for the electronic document, a document-specific asymmetric encryption key. The method includes identifying, for the user identifier, a user-specific signature key. The method includes generating a digital representation of the change event containing a context identifier for a state of the electronic document prior to the change event and an instruction for effecting the change event. The method includes generating, using the user-specific signature key, a cryptographic signature of the digital representation of the change event. The method includes encrypting, using the document-specific asymmetric encryption key, the digital representation of the change event. The method includes generating an operation capsule containing the encrypted digital representation of the change event and the cryptographic signature.

In at least one aspect, the disclosure pertains to a method of secure collaboration. The method includes detecting, for an electronic document, a permissions change event associated with a user identifier. The method includes identifying, for the user identifier, a user-specific signature key. The method includes generating a digital representation of the change event containing a context identifier for a state of the electronic document prior to the permissions change event and an instruction for effecting the change event. The method includes generating, using the user-specific signature key, a cryptographic signature of the digital representation of the permissions change event. The method includes generating an operation capsule containing the digital representation of the permissions change event and the cryptographic signature. In some implementations of the method, the digital representation of the permissions change event is included in the operation capsule in an unencrypted form.

In at least one aspect, the disclosure pertains to a method of secure collaboration. The method includes receiving, for an electronic document, a collaborator operation capsule containing a collaborator identifier, a digital representation of a collaborator change event, and a collaborator signature for the digital representation of the collaborator change event. The method includes authenticating the collaborator signature using a collaborator-specific signature verification key. The method includes verifying, in a set of permissions associated with the electronic document, that the collaborator identifier has authorization to perform the collaborator change event. The method includes applying the change event to the electronic document. In some implementations, the change event is only applied to the electronic document responsive to successfully authenticating the collaborator signature and verifying that the collaborator identifier has authorization to perform the collaborator change event. In some implementations, the change event is encrypted with a document-specific asymmetric encryption key and the method includes locating an encrypted copy of a corresponding document-specific asymmetric decryption key and decrypting the encrypted copy of the corresponding document-specific asymmetric decryption key using a user-specific asymmetric decryption key.

In at least one aspect, the disclosure pertains to a system that includes computer-readable memory and a computer processor. The memory stores a sequence of operation capsules for a document, each operation capsule containing a respective source identifier, a respective digital representation of a respective change event attributable to the respective source identifier, a respective cryptographic signature for the respective digital representation of the respective change event, and a respective sequence identifier, wherein at least one operation capsule in the sequence of operation capsules comprises an encrypted digital representation of its respective change event, the encrypted digital representation encrypted using a document-specific asymmetric encryption key. The computer processor is configured to receive a new operation capsule for a document, assign a new sequence identifier to the new operation capsule, and add the new operation capsule, with the new sequence identifier, to the sequence of operation capsules for the document. In some implementations, the processor is further configured to notify, via a network, at least one client device of an availability of the new operation capsule. In some implementations, the processor is further configured to transmit, via the network, the new operation capsule to at least one client device.

### BRIEF DESCRIPTION OF THE DRAWINGS

The above and related objects, features, and advantages of the present disclosure will be more fully understood by reference to the following detailed description, when taken in conjunction with the following figures, wherein:

FIG. 1 is a block diagram illustrating an example network environment for use in secure collaboration across a public network;

FIG. 2A is a block diagram illustrating a four-layer stack for modeling the described systems and methods;

FIG. 2B is a block diagram illustrating an example implementation of the four-layer stack shown in FIG. 2A;

FIG. 3A is a block diagram illustrating an example operation;

FIG. 3B is a block diagram illustrating an example operation sequence for a document;

FIG. 3C is a block diagram illustrating an example client view of a shared collaborative document;

FIG. 4 is a flowchart illustrating a method for facilitating a document editor accessing an electronic document;

FIG. 5 is a flowchart for a method of merging operations;

FIG. 6 is a flowchart for a method of propagating a modification among collaborators;

FIG. 7 is a flowchart for a method of receiving and distributing operation data;

FIG. 8 is a flowchart for a method of revoking reader permissions; and

FIG. 9 is a block diagram illustrating a general architecture of a computing system suitable for use in some implementations described herein.

The accompanying drawings are not intended to be drawn to scale. Like reference numbers and designations in the various drawings indicate like elements. For purposes of clarity, not every component may be labeled in every drawing.

### DETAILED DESCRIPTION

The following systems and methods for secure collaboration enable precise access management. Collaborators each maintain their own copy of a collaborative document. When a collaborator alters his or her local copy, the modification is captured and propagated to the other collaborators. On receipt of a modification, the modification is validated and, if valid, applied to the local copy. Validation includes authenticating the source of the modification and verifying that that the source is authorized to make the modification. Access control data, maintained in parallel with the collaborative document, identifies specific operations that each collaborator is authorized to perform on the document. Operations that are not authorized are rejected. In addition, when multiple operations are received representing a potential conflict, operational transforms are used to resolve any conflict.

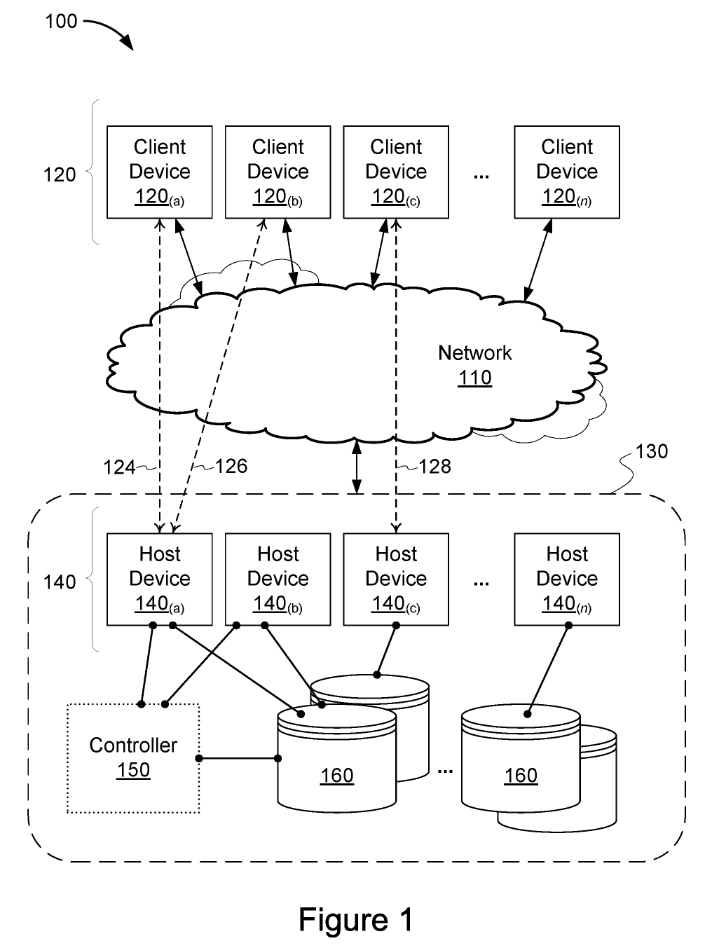

FIG. 1 is a block diagram illustrating an example network environment 100 for use in secure collaboration across a public network 110. In broad overview, shown in FIG. 1 are a network 110, client devices 120₍ₐ₎-120₍ₙ₎ (generally, client devices 120), and a collaboration platform host 130. The collaboration platform host 130, as shown, includes one or more host devices 140₍ₐ₎-140₍ₙ₎ (generally, host devices 140), managed by a controller 150 and sharing storage resources 160.

The collaboration platform host 130 provides the infrastructure for a collaboration platform used to facilitate secure collaboration between users of the client devices 120 over the network 110. A first client device 120₍ₐ₎ may send (or receive) data 124 to (from) a host device 140₍ₐ₎ and a second client device 120_{(b)}may receive (or send) data 126 from (to) the host device 140₍ₐ₎. The host devices 140 may share access to storage resources 160, as shown. Accordingly, a client device 120_{(c)} may exchange data 128 with a host device 140_{(c)} other than the specific host device 140₍ₐ₎ instance used by other collaborators.

Referring to FIG. 1 in more detail, the network 110 facilitates communication (e.g., communications 124, 126, and 128) between the client devices 120 and the collaboration platform host 130. Examples of networks include a local area network (“LAN”), a wide area network (“WAN”), an inter-network (e.g., the Internet), and peer-to-peer networks (e.g., ad hoc peer-to-peer networks). The network 110 may be composed of multiple connected sub-networks and/or autonomous systems. In some implementations, the network 110 can be a corporate intranet, a metropolitan area network (MAN), or a virtualized network. In some implementations, the network 110, or portions of the network 110, adheres to the multi-layer Open System Interconnection (“OSI”) networking framework (“OSI Model”). Any type and/or form of data network and/or communication network can be used for the network 110. It can be public, private, or a combination of public and private networks. In general, the network 110 is used to convey information between computing devices.

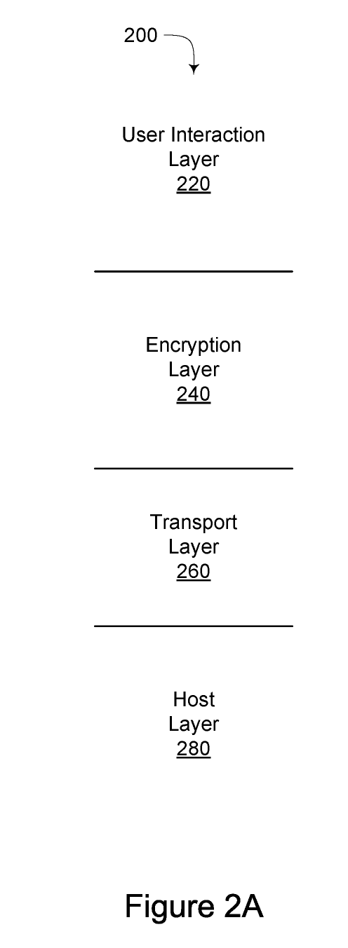

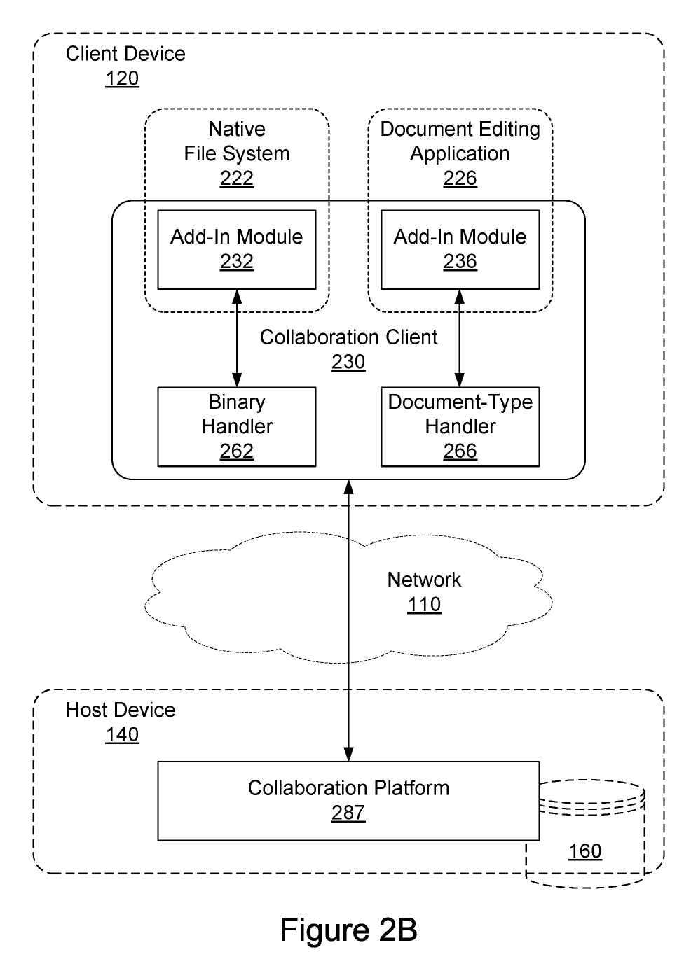

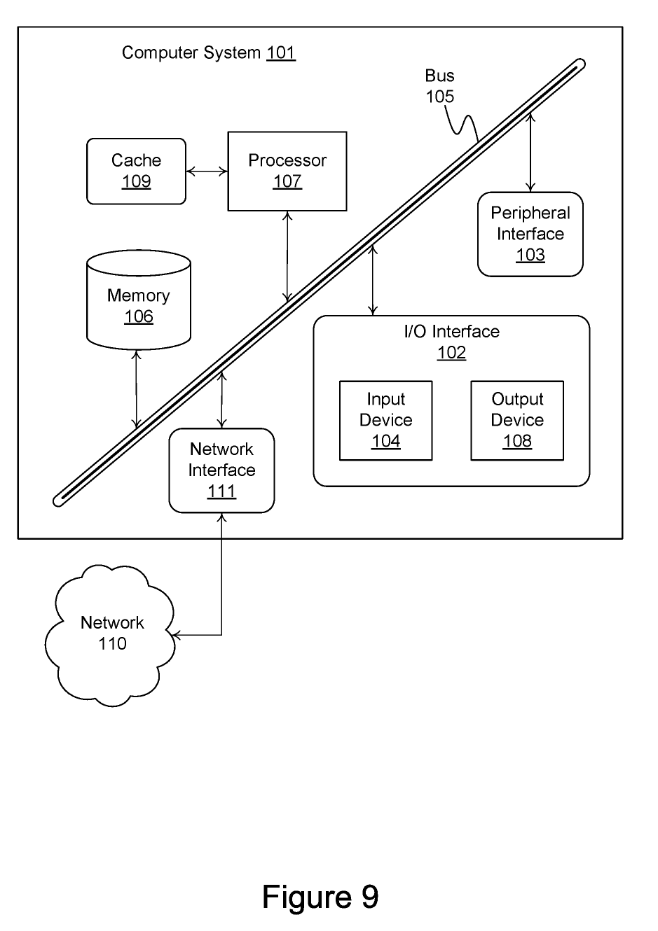

Client devices 120 include, but are not limited to, computing devices used by collaborators. Each client device 120 provides one or more respective collaborators with tools for viewing and/or editing collaborative documents and for managing security for real-time (or near-real time) collaboration. In some implementations, these tools are implemented, respectively, as an editing application and a collaboration client application, which are described in more detail below in reference to FIGS. 2A and 2B. In broad overview, in some implementations, a client device 120 executes a collaboration application and a document access application such as a text editor, a word processor, a spreadsheet application, a presentation application, an image editor, an audio editor, a video editor, a graphical webpage editor, or any other such document access application. The collaboration client application provides a document to the document access application, and the document access application presents the document on an output device such as a display screen, a speaker, or a printer. A document access application that only reads the document, and does not alter the document, may be referred to as a document viewer. In some implementations, the document access application facilitates modification of the document by a user. A document access application that facilitates modification of the document is referred to as a document editor. If the user does not submit modifications to the document, or cannot submit modifications to the document, there is no practical difference between a document viewer and a document editor. Accordingly, for simplicity, document access applications are referred to as document editors without intent to exclude document access applications that lack modification capabilities, i.e., document viewers. FIG. 9, described below, illustrates an example computing device 101 suitable for use as a client device 120.

The collaboration platform host 130 provides the infrastructure for a collaboration platform used to facilitate secure collaboration between users of the client devices 120 over the network 110. In some implementations, the platform host 130 is operated by an untrusted or unreliable third-party. For example, in some implementations, the platform host 130 is a cloud services provider. In some implementations, the platform host 130 only serves as a data depot and is not required to provide any additional functionality. In some implementations, the platform host 130 provides additional functionality. For example, in some such implementations, the platform host 130 provides sequencing counters. In some implementations, the platform host 130 pushes notifications to each client 120 when data is uploaded to the platform host 130. In some implementations, the platform host 130 hosts a collaboration platform, which is described in more detail below in reference to FIGS. 2A and 2B.

Host devices 140 include, but are not limited to, computing devices used to host or provide access to the collaboration platform 130. In some implementations, the host devices 140 are operated by a third-party, e.g., a cloud services provider. In some implementations, the host devices 140 are virtualized. In some implementations, the client devices 120 form a peer-to-peer network and serve both as client devices 120 and as host devices 140. FIG. 9, described below, illustrates an example computing device 101 suitable for use as a host device 140.

The controller 150 controls, configures, or otherwise manages the host devices 140. For example, in some implementations, the host devices 140 may be part of a cloud platform for tenancy computing. In such implementations, the controller 150 may be the controller for the cloud. In some implementations, the host devices 140 are configured via the controller 150. For example, in some implementations, the controller 150 provides an administrative interface for the services and functionality provided by the host devices 140. In some implementations, the controller 150 configures access to the storage resources 160.

The storage resources 160 may each be implemented using one or more data storage devices. The data storage devices may be any memory device suitable for storing computer readable data. The data storage devices may be a device with fixed storage or a device for reading removable storage media. Examples include all forms of non-volatile memory, media and memory devices, semiconductor memory devices (e.g., EPROM, EEPROM, SDRAM, and flash memory devices), magnetic disks, magneto optical disks, and optical discs (e.g., CD ROM, DVD-ROM, or BLU-RAY discs). Example implementations of suitable data storage devices include storage area networks (“SAN”), network attached storage (“NAS”), and redundant storage arrays. Data may be recorded as data files in a file system or as data in a knowledge base, object database, relational database, or other data organizing structure. In some implementations, all or portions of the data is recorded in an encrypted form.

FIG. 2A is a block diagram illustrating a four-layer stack 200 for modeling the described systems and methods. A user interaction layer 220 represents user applications and add-in modules with which collaborators directly interact. An encryption layer 240 represents the client-side tools used to secure collaboration and provide authentication and privacy. A transport layer 260 represents the communication between the client-side and the server-side, e.g., over a network. Finally, the host layer 280 represents the server-side facilitating distribution of information between clients.

The user interaction layer 220 represents user applications and add-in modules with which collaborators directly interact. It may also include an administrative user interface provided at a client device 120.

The encryption layer 240 represents the client-side tools used to secure collaboration and provide authentication and privacy. In general, the encryption layer 240 relies cryptographic hash functions and key-based encryption schemes.

Cryptographic hash functions, e.g., the Secure Hash Algorithm “SHA-3”, are designed to be irreversible while having a low probability of collision for similar inputs. A hash function is irreversible if, for a given result of the hash function, it is difficult or impossible to determine what input was used to obtain the given result. A hash function that generates the same result for a large number of different possible inputs is likely to be irreversible. However, when two different input values result in the same hash function result, the input values are said to collide. A hash function that generates the same result on similar input has a high likelihood of collisions. A hash function that generates different results for similar input values has a lower likelihood of collisions. A good cryptographic hash function will return a hash function result from which it is difficult or impossible to determine the input, while having a low likelihood that two similar input values have the same hash function result. The result of a hash function is a hash value. Accordingly, a hash value computed by applying a cryptographic hash function to a large block of data is a good representation of the data. Examples of cryptographic hash functions include MD5, Skein, and the Keccak family, which includes SHA-3.

Key-based encryption schemes can be divided into symmetric key schemes like AES and asymmetric key schemes like RSA. In a symmetric key scheme, a single key is used both to encrypt and decrypt data. In an asymmetric key scheme, there are two keys—a private key and a public key—and data encrypted with one key can only be decrypted using the other. As indicated by their names, the private key is kept private to a single user while the public key is made public.

One advantage of asymmetric encryption is that data can be encrypted for a particular recipient without the need for an out-of-band key exchange. Data for the recipient can be encrypted using the recipient's public key such that only the recipient's private key can be used to decrypt it. However, compared to symmetric encryption schemes, asymmetric encryption is slow and unwieldy. Accordingly, when encrypting large blocks of data, one strategy is to generate a random symmetric key, encrypt the data with a symmetric scheme using the generated random symmetric key, encrypt the generated random symmetric key with an asymmetric key, and pair the symmetrically encrypted block of data with the asymmetrically encrypted key. This is referred to as a two-phase encryption scheme. Whenever this document refers to asymmetric encryption, the two-phase encryption can be used. In some instances, the data to be encrypted will be small enough to be directly encrypted using asymmetric encryption.

Another advantage of asymmetric encryption is attribution. If a user's public key works to decrypt data, then that data was likely encrypted by the user's private key. The digital signature algorithm (“DSA”) can be used to authenticate a cryptographic signature. In simplified overview, a block of data can be signed by encrypting the data, or more particularly, by signing a cryptographic representation of the data, using a private signature key. An example of a cryptographic representation of the data is a hash of the data. Anyone can decrypt the signature using the corresponding public signature verification key and compare the decrypted data to signed data, or rather to a corresponding representation of the signed data. The asymmetric keys used for encryption can be used for signatures, or different keys can be maintained solely for signatures.

Public keys are distributed freely, while private keys are kept private to their respective users. Although no out-of-band key transfer is required, there is a concern in verifying the authenticity of a public key. A user needs to trust that a particular public key corresponds to a private key held only by an intended recipient. In some implementations, a public key is signed by a trust authority attesting that the key belongs to the corresponding user.

Referring still to FIG. 2A, a transport layer 260 represents the communication between the client-side and the server-side, e.g., over a network. Because private data transmitted is encrypted, the network can be a public network without a loss of privacy. Failures and blockages in the network may result in a denial of service, but the information transmitted is otherwise secure.

The host layer 280 represents the server-side facilitating distribution of information between clients. In some implementations, the host layer 280 is simply a data server allowing all participants to read and write data. In some implementations, the host layer 280 allows all participants to read and write data, but not to overwrite data. In some implementations, the host layer 280 provides additional functionality, e.g., assigning global sequence numbers to incoming data, distributing public keys, and administering user identifications. In some implementations, the host layer 280 is handled by the participant clients themselves, e.g., in a peer-to-peer fashion. In some such implementations, the clients elect a particular client to handle administrative functions.

FIG. 2B is a block diagram illustrating an example implementation of the four-layer stack 200 shown in FIG. 2A. With reference to FIG. 1, a client device 120 is shown in FIG. 2B hosting a native file system 222 and a document editing application 226. A collaboration client 230 is installed in the client device 120 and exchanges data, via the network 110, with a collaboration platform 287 installed at a host device 140. The collaboration client includes add-in modules 232 and 266, which facilitate interactions between the collaboration client and, respectively, the native file system 222 and the document editing application 226. For example, file change events in the native file system 222 are identified by the native file system add-in module 232 and reported to a binary data-type handler 262. The binary handler 262 identifies that a file has changed. In some implementations, the binary handler 262 identifies specific changes to a file and generates operation data representing the specific changes. In some implementations, the native file system add-in module 232 can detect a document type for a modified binary file and send the binary file to a document-type specific handler 266 for the correct document type. Similarly, the collaboration client 230 includes one or more application-specific add-in modules 236, which each report application-specific events to a corresponding application or document-type specific handler 266. The document-type handler 266 identifies specific changes to a file of the corresponding document type and generates operation data representing the specific changes. In some implementations, the operation data is structured as operations for a particular document type. For example, in some implementations, edits to a text document are structured as string edit operations. The collaboration client 230 distributes the operation data from the data handler 262 and 266 to other clients, e.g., via the collaboration platform 287, and the other clients apply the operation data locally. Effectively, a change at one client is made to occur at all clients.

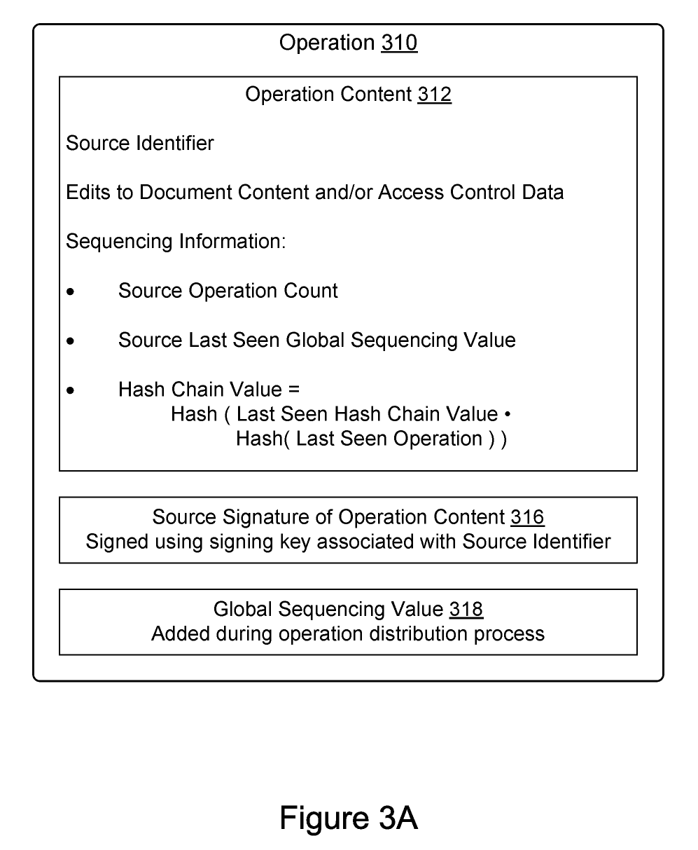

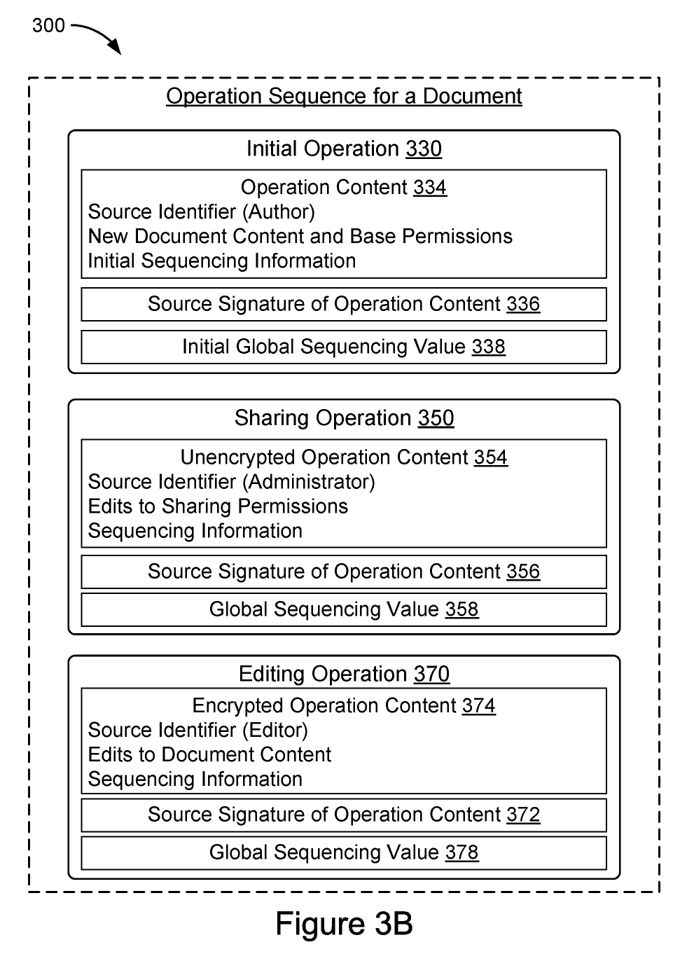

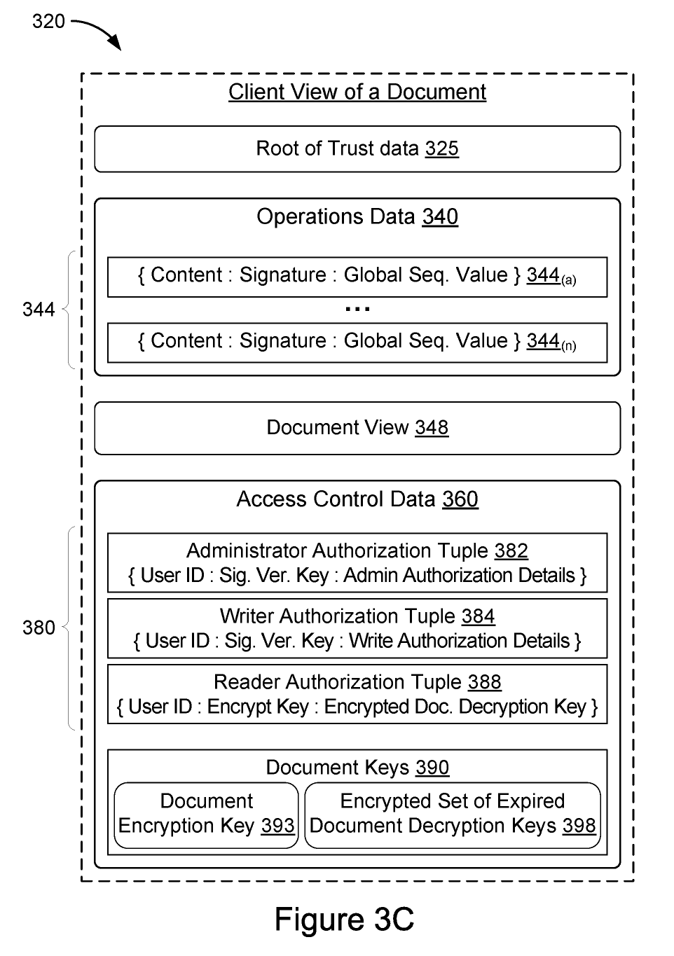

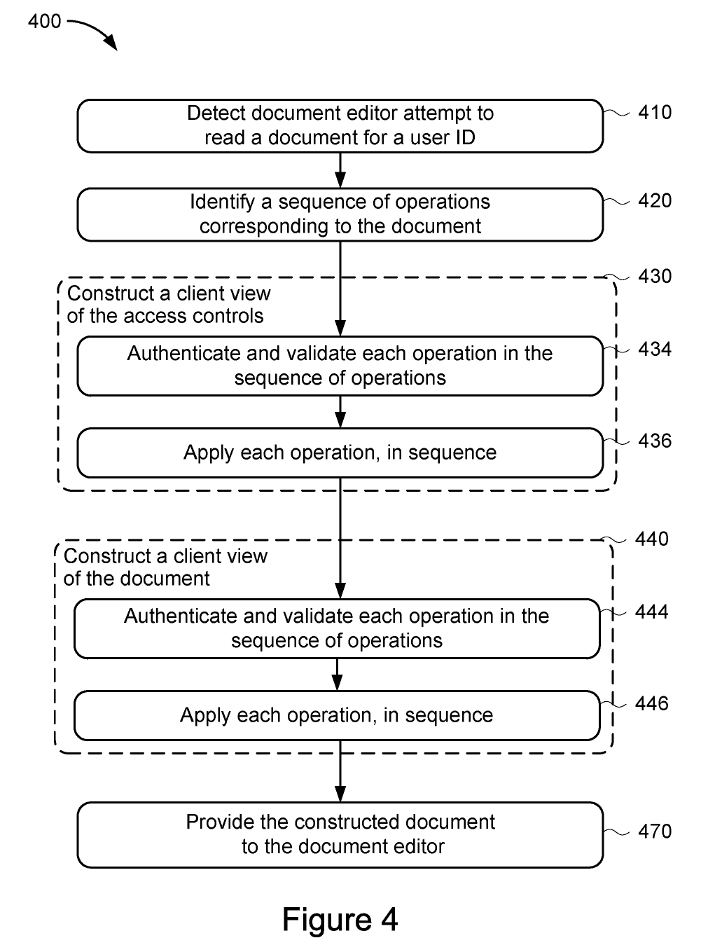

Referring to FIG. 2B in more detail, the client device 120 executes a collaboration client 230. The collaboration client 230 detects any changes to a collaborative document made by a document editor and captures these changes as operations for distribution to other client devices 120. FIG. 3A, described in more detail below, illustrates an example of an operation. A sequence of operations from an initial operation creating the document through any number of editing operations may be used to construct a current view of the document. FIG. 3B, described in more detail below, illustrates a sequence of operations. In some implementations, the collaboration client 230 maintains a record of a sequence of operations. In some implementations, the collaboration client 230 maintains a document view based on the sequence of operations. FIG. 3C, described in more detail below, illustrates an example client view 320 for a collaborative document. When a document editing application 226 attempts to access the document, the collaboration client 230 generates a document view to provide to the document editing application 226. For example, in some implementations, the collaboration client 230 generates a temporary file to be opened by the document editing application 226. In some implementations, the collaboration client 230 includes a file system driver (e.g., a file-system add-in module 232) that hooks an application's request for file content (i.e., a file system access call) and responds to the request with document data generated by the collaboration client 230. An example method 400 for generating document content (as a document view) from a sequence of operations is described in more detail below in reference to FIG. 4. In some implementations, the collaboration client 230 uses the method 400 to generate document content for responding to a document editing application 226 attempt to access the document.

The collaboration client 230 also manages user data for a collaborative user. In particular, each collaborative user has a public key that is distributed to other collaborative users and a corresponding private key retained solely for use by the particular user. In some implementations, the collaboration client 230 manages a local copy of the private key. In some implementations, the collaboration client 230 generates the public and private key pair. The key pair may be generated using any adequately secure asymmetric key scheme. For example, in some implementations, the public and private keys are generated for use in any of the RSA asymmetric encryption schemes. In some implementations, the asymmetric encryption scheme “Cramer-Shoup” is used instead. Any suitably secure asymmetric encryption scheme may be used. In some implementations, distribution of the public keys is handled within the interactions between the collaboration client 230 and the collaboration platform 287. Accordingly, out-of-band key distribution is not generally required. In some implementations, the collaboration client 230 accepts out-of-band public keys signed with third-party trust certificates to establish a root of trust.

The collaboration client 230 distributes operation data for local change events to collaborators. In some implementations, the collaboration client 230 distributes operation data by uploading the data, via the network 110, to a collaboration platform 287. In some implementations, the collaboration platform 287 assists in resolving operation conflicts by assigning a globally unique sequence number to each incoming operation. In some implementations, the collaboration client 230 distributes operation data directly to collaborator client devices 120, e.g., using a peer-to-peer network.

In some implementations, the collaboration client 230 relies on one or more add-in modules, e.g., the native-file system add-in module 232 and the document editing application specific add-in module 236, to detect change events.

The file system add-in module 232 detects changes in the native file system 222. For example, in some implementations, the file system add-in module 232 hooks system calls to the native file system 222 and intercepts calls to write data to, or to read data from, the file system 222. In some implementations, the collaboration client 230 detects changes when a document is saved, e.g., by monitoring a file system or by receiving a notification from the file system. In some implementations, the file system add-in module 232 periodically polls the native file system 222 for modifications. For example, in some implementations, the file system add-in module 232 maintains a set of file identifiers, each associated with a respective value for a last-modified date; every few seconds the file system add-in module 232 looks at file system metadata for each file in the set and determines if the last-modified date in the file system has changed from the value indicated in the maintained set. The polling interval can be fixed (e.g., every two seconds), variable (e.g., every five seconds unless the file has been changed in the last ten seconds, in which case every second), or user configurable. In some implementations, only files that have been recently accessed through the collaboration client 230 are monitored for changes. In some implementations, the collaboration client 230 generates temporary files for access use and only these temporary files are monitored for changes. In some implementations, the collaboration client 230 maintains a copy of each monitored file in a known state. Upon detecting a change event, and determining that the change event is complete, the collaboration client 230 compares the updated file to the copy and determines, from the comparison, what has changed. The collaboration client 230 then generates operation data representing the change. Application of the operation data to the copy of the file results in the updated file. Accordingly, the copy of the monitored file plus all operations subsequent to creating the copy is equivalent to the updated file.

For each type of data to be monitored, the collaboration client 230 has a data-type specific handler. For example, as shown in FIG. 2B, the collaboration client 230 includes a binary handler 262 and a document-type hander 266. Each data-type handler describes all of the valid operations that can be performed on the respective data type, as well as how to do Operation Transformation (OT) on those operations. Additionally, in some implementations, the add-in modules pass change information to the corresponding data type handler, and the handler identifies operations for effecting the detected change.

The document editing application specific add-in module 236 interacts directly with the particular document editing application 226 to which it corresponds. In some implementations, with some document editing applications 226, the collaboration client 230 can provide greater visibility into document modifications. In some implementations, the collaboration client 230 includes an application-specific add-in module 236 that can identify change events. In some implementations, the application-specific add-in module 236 captures context for the modifications and enables a more granular understanding of the modification, which can then be used for more granular write permissions. In some implementations, the document access application provides an Application Programming Interface (“API”) for use by the collaboration application. In some implementations, the document access application enables inter-process communication, e.g., using a Component Object Model (“COM”) or COM derivative. In some implementations, the collaboration application includes one or more add-in modules 236 that are installed into, or atop of, a document editing application 226. The add-in modules detects changes and notifies the collaboration application. In some implementations, the add-in module is tailored to a specific document access application. For example, the add-in module for a word processor such as MICROSOFT WORD may be different from the add-in module for a presentation editor such as MICROSOFT POWERPOINT. Further, the add-in module for one word processor, e.g., MICROSOFT WORD, may be different from the add-in module for another word processor, e.g., APACHE OPENOFFICE WRITER.

In some implementations, the collaboration client 230 includes an add-in module 236 for use with a document editing application 226 that provides a representation of document content as that content is presented to a user. When the user modifies the content, the add-in module 236 detects the edits in real-time, or in near real-time. For example, in some such implementations, the document editing application 226 notifies the add-in module 236 of each change to the representation of document content. In some implementations, the add-in module 236 periodically polls the document editing application 226 for changes to the representation of document content. For example, in some such implementations, the add-in module 236 maintains a shadow copy of the representation of document content and periodically requests a fresh copy of the representation of document from the document editing application 226; the add-in module 236 then compares the shadow copy to the fresh copy and determines what, if anything, has changed. In some implementations, the add-in module 236 is notified when a user of the document editing application 226 submits a request to save the document. In some implementations, the add-in module 236 captures changes to the document prior to any request to save the document.

The collaboration client 230 captures document content modifications and generates an operation representative of the document content modifications. When there is a sufficient lull in modifications, and when the collaboration client 230 has access to a collaboration platform 287, the collaboration client 230 packages the operations into a single operation for distribution and submits the operation to the collaboration platform 287. In some implementations, prior to submitting an operation to the collaboration platform 287, the collaboration client 230 first downloads any pending operations. In some such implementations, the collaboration client 230 merges the downloaded operations with the local document view and resolves any content modification conflicts prior to uploading the new operation to the collaboration platform 287. In some such implementations, the collaboration client 230 uses operational transforms to merge the downloaded operations.

FIG. 3A is a block diagram illustrating an example operation 310. The operation 310 represents a change in a document performed by a user or account. The document includes both document content and document access control data, e.g., an access control list (“ACL”). When a user modifies document content, or access controls for a document, the modifications are bundled by the collaboration client 230 into an operation 310, which the collaboration client 230 then distributes, e.g., by uploading to a collaboration platform 287. The operation 310 includes operation content 312, a source signature 316, and a global sequencing value 318.

The operation content 312 includes a source identifier, data representing edits to the document and/or edits to the access control data, and sequencing information. The source identifier identifies the user or account responsible for creating the operation. In some implementations, the source identifier is a user identifier. In some implementations, the source identifier is an account identifier. In some implementations, the data representing edits to the document and/or edits to the access control data is a set of instructions for transitioning the document from a previous state to a new state. In some implementations, the data representing edits to the document and/or edits to the access control data is suitable for use in operational transforms.

The sequencing information includes data used to place the operation in proper context. In some implementations, the sequencing information includes an operation identifier. In some implementations, the sequencing information includes a count of operations performed at the source collaboration client 230. In some implementations, the sequencing information includes a last seen global sequencing value, that is, a global sequencing value from a previously seen operation. In some implementations, the sequencing information includes a hash chain value. In some implementations, the hash chain value is a result of a hash function applied to a last seen hash chain value concatenated with a hash of a last seen operation. The operations 310 sent to, or received from, a collaboration platform 287 may be referred to as committed operations. In some implementations, a collaboration client 230 identifies a last committed operation and identifies, from the last committed operation, a last seen global sequencing value and a last seen hash chain value. The collaboration client 230 then uses the identified last seen global sequencing value and last seen hash chain value to form sequencing information for a new operation 310.

The operation content 312 may be encrypted or unencrypted. In some implementations, operations that include edits to document content are encrypted and operations that include edits to access control data are not encrypted. In some implementations, operations are encrypted unless the operation adds access permissions for a new user. In some implementations, operations are not encrypted. For example, in some implementations, the collaborators only require attribution and do not require privacy. In some implementations, a user can decide which operations are to be encrypted and configure the collaboration client 230 accordingly.

The operation 310 includes a source signature 316. Each collaborator for a document has, for each user identifier authorized to make changes to the document, a corresponding verification key. When the collaboration client 230 generates the operation 310, it includes a signature of the operation content 312 created using a signing key associated with the source identifier. Collaborators can then verify that the operation 310 originated with the source identified in the operation content 312 by verifying the signature 316 using a verification key associated with the source identifier.

The operation 310 includes a global sequencing value 318. In some implementations, the collaboration client 230 creates the operation 310 without the global sequencing value 318 and the global sequencing value 318 is added later, e.g., before other clients receive and process the operation 310. In some implementations, the global sequencing value 318 is added when the operation 310 is distributed. In some implementations, the global sequencing value 318 is assigned by the collaboration platform 287 when the operation 310 is committed. The global sequencing value 318 is used to impose a sequence on the operations 310, but the sequence is verifiable using the hash chain value. Accordingly, in some implementations, the global sequencing value 318 does not have to come from a trusted or reliable source. In some implementations, the global sequencing value 318 is a timestamp added by the collaboration client 230 when the operation is shared. Even if the clients did not precisely agree on the time, as long as the clients generally agree on the time within a threshold variance, the assigned global sequencing values 318 would still have a consistent ordering. In some implementations, other information is used to generate a global sequencing value 318.

FIG. 3B illustrates an example operation sequence 300 for a document. The example sequence 300 begins with an initial operation 330, which includes operation content 334, a source signature 336, and an initial global sequencing value 338. The initial operation 330 is followed by one or more sharing operations 350 and editing operations 370. A sharing operation 350 includes operation content 354 specifying edits to sharing permissions, a source signature 356 for the operation content 354, and a global sequencing value 358. A document editing operation 370 includes operation content 374 specifying edits to the document content, a source signature 376 for the operation content 374, and a global sequencing value 378.

As shown in FIG. 3B, an initial operation 330 creates a document. In some implementations, the operation content 334 for the initial operation 330 only establishes sharing permissions for a base permission set. In some implementations, the operation content 334 for the initial operation 330 includes initial document content and establishes a base permission set. The base permission set includes permissions for the author of the document, granting the author authorization to create the document and to share it with collaborators. The initial operation 330 includes a signature 336 and, when distributed, a global sequencing value 338.

After creating an initial operation 330 for a document, a source of the document shares the document with other users (i.e., collaborators). Sharing a document includes granting a new permission to a collaborator. If all operations are encrypted, the new collaborator will be unable to decrypt the new authorization absent a proper decryption key. Accordingly, in some implementations, sharing operations 350 include unencrypted operation content 354 with edits to sharing permissions. However, as with any operation 310, the sharing operation content 354 includes a source identifier, e.g., identifying an administrator with authorization to change sharing permissions, data representing edits, and sequencing information. The sharing operation 350 includes a signature 356 and, when distributed, a global sequencing value 358.

Users with editor permissions can then edit the document. When an editor modifies document content, a collaboration platform 230 generates an operation with data representing the edits. In some implementations, the content 374 for an editing operation 370 is encrypted to ensure privacy of the document content to the collaborators. As with any operation 310, the editing operation content 370 includes a source identifier, e.g., identifying an editor with authorization to change document content, data representing edits, and sequencing information. The editing operation 370 includes a signature 376 and, when distributed, a global sequencing value 378.

As users modify permissions and document content, each user's respective collaboration client 230 generates appropriate sharing operations 350 and editing operations 370 and distributes them to collaborators. In some implementations, a collaboration client 230 distributes operations 310 to collaborators by uploading the operations 310 to a collaboration platform 287. When a collaborator uploads an operation 310 to the collaboration platform 287, the platform 287 assigns the operation 310 a global sequencing value 318, 338, 358, or 378. The collaboration platform 287 stores the operations and provides the operations to clients. A new collaborator can retrieve an entire sequence of operations, from an initial operation 330 through all subsequent sharing operations 350 and editing operations 370. The new collaborator can then process the operations 310 to create a local view of the document.

FIG. 3C is a block diagram illustrating an example client view 320 of a shared collaborative document. As shown in FIG. 3C, the collaboration client 230 obtains operations data 340, e.g., from a collaboration platform 287, and constructs a local document view 348 and access control data 360. Generally, the collaboration client 230 has some item of information used to establish a root of trust 325 in the document. For example, the collaboration client 230 may have an authenticated copy of the document's original author signature verification key for use as the root of trust data 325. The collaboration client 230 establishes, using the root of trust data 325, trust in a first operation 344₍ₐ₎ (e.g., an initial operation 330) and builds trust in the operations 344₍ₐ₎-344₍ₙ₎ (generally, operations 344) while constructing the local document view 348 and access control data 360. Each operation 344 may be a sharing operation 350 or an editing operation 370. The sharing operations 350 are used to modify and update the access control data 360 while the editing operations 370 are used to modify and update the document view 348. The document view 348 is the document content as may be presented to a document editing application 226. The access control data 360 includes one or more user authorization tuples 380 and a set of document keys 390. The user authorization tuples 380 specify which users may modify authorizations, edit document content, and/or read document content. Furthermore, the user authorization tuples 380 include specific rules regarding what a user may do with the granted authorization. An administrator authorization tuple 382 includes a user identifier, a signature verification key, and specific details for the administrative authorizations granted to the identified user. An editor authorization tuple 384 includes a user identifier, a signature verification key, and specific details for the editing authorizations granted to the identified user. A reader authorization tuple 388 includes a user identifier, an asymmetric key, and a copy of a document decryption key that has been encrypted with the asymmetric key. The asymmetric key in the reader authorization tuple 388 is specific to the corresponding user and is for use in encrypting data to be provided to the corresponding user. Accordingly, the user will be able to use his or her own decryption key to retrieve the document decryption key 393 from the reader authorization tuple 388. The client view 320 includes a set of document keys 390 that include the document encryption key 393 and an encrypted set of expired document decryption keys 398. The document encryption key 393 and the decryption key are a key pair for an asymmetric encryption scheme such as RSA. In some implementations, the set of expired document decryption keys 398 is encrypted using the current document encryption key 393.

The access control data 360 includes one or more sets of user authorization tuples 380. Each tuple includes at least a public key (e.g., a signature verification key or an encryption key) for a corresponding user and an indication of authorization granted to the corresponding user. In some implementations, each tuple includes an identifier for the corresponding user. In some implementations, as shown, the user identification tuples 380 in the access control data 360 may be divided into three sets: a set of administrator authorization tuples 382, a set of editor authorization tuples 384, and a set of reader authorization tuples 388, and each tuple includes at least the user identifier, a public key, and authorization information. However, other data structures can be used to accomplish the same objectives. Any suitable data structure may be used. In some implementations, the user authorization tuples 380 are represented in a single data structure.

The user authorization tuples 380 for the administrative permissions 382 each include specific indication of the authorization associated with a corresponding user. One or more users may be identified as having full administrative permissions. Some users may be granted limited administrative permissions. For example, some users may be granted permission to change their own public-private key pairs and to update the access control data 360 accordingly, but without authorization to change anyone else's key pairs. In some implementations, a user may be granted permission to grant read permissions to new users, but not to revoke read permissions or grant write permissions. Any authorization or permission that can be specified in the access control data may be granted.

The user authorization tuples 380 for the editor permissions 384 each include specific indication of the authorization associated with a corresponding user. One or more users may be identified as having full document write permissions. Some users may be granted limited write permissions. For example, some users may be granted permission to add new pages, with new content, to a document but not to remove pages or modify content on other pages. In some implementations, a user may be granted write permissions without being granted read permissions.

The user authorization tuples 380 for the reader permission tuples 388 each include specific indication of the authorization associated with a corresponding user. In some implementations, read permission is granted simply by providing the user with access to a document-specific decryption key. The document-specific decryption key is encrypted using the user's specific public key and stored, encrypted, in the user's reader permission tuple 388.

FIG. 4 is a flowchart illustrating a method 400 for providing a document editor 226 with access to an electronic document. In broad overview, in the method 400, at stage 410, a collaboration client 230 executing on a client device 120 detects that a document editor 226 executing on the client device 120 is attempting to access a document on behalf of a user identifier. At stage 420, the collaboration client 230 identifies a sequence of operations 300 corresponding to the document. At stage 430, the collaboration client 230 constructs a client view of the access controls for the document from the sequence of operations 300. Constructing the access controls includes, at stage 434, authenticating and validating each access control modification operation in the sequence of operations and, at stage 436, applying each access control modification operation, in sequence. At stage 440, the collaboration client 230 constructs a client view of the document content from the sequence of operations 300. Constructing the client view of the document content includes, at stage 444, authenticating and validating each operation in the sequence of operations and, at stage 446, applying each operation, in sequence. Then, at stage 440, the collaboration client 230 provides the constructed document content to the document editor application 226.

Referring to FIG. 4 in more detail, in the method 400, at stage 410, a collaboration client 230 executing on a client device 120 detects that a document editor 226 executing on the client device 120 is attempting to access a document on behalf of a user identifier. In some implementations, prior to attempting to access the document, the user activates the collaboration client 230 on the client device 120 and authenticates a user identifier. In some such implementations, activity by the document editor 226 on the client device 120 subsequent to authenticating the user identifier are presumed to be on behalf of the authenticated user identifier. In some implementations, the collaboration client 230 includes an add-in 236 that intercepts or hooks a document open instruction. In some implementations, the document editor 226 attempts to open a data file in the native file system 222 and a system add-in module 232, e.g., a file driver, intercepts or hooks the file open instruction.

At stage 420, the collaboration client 230 identifies a sequence of operations 300 corresponding to the document, e.g., as shown in FIG. 3B. The collaboration client 230 loads the operations 300 for the document being accessed, constructing a client view 320, e.g., as shown in FIG. 3C. In some implementations, the operation data is stored at the client device 120 by the collaboration client 230. In some implementations, the collaboration client 230 retrieves the operation data from a host device 140. In some implementations, the collaboration client 230 retrieves the operation data from a collaboration platform 287. In some implementations, the collaboration client 230 has a local cache of operation data and updates the local cache by retrieving any missing operation data from the collaboration platform 287. In some implementations, the operation data is associated with a file name or file identifier. In some implementations, the operation data is identified by a uniform resource locator (“URL”).

Operations are applied in sequence, based on the order in which the operations were distributed. When each operation is packaged for sharing, it is bundled with a hash value representative of a previous operation. In some implementations, the hash value is a hash chain value equal to the result of a hash function applied to the hash chain value from a previous operation concatenated with a hash of the previous operation. Each collaboration client 230 can verify that an operation is correctly placed in sequence after a prior operation by reconstructing the hash chain value and comparing the reconstructed hash chain value to the hash chain value present in the new operation. In some implementations, operations are distributed by uploading the operation to a collaboration platform 287. The collaboration platform 287 assigns a global sequencing number to each operation upon receipt. In some implementations, the collaboration clients 230 use these global sequencing numbers to place the operations in a presumptive order and then verify the correctness of the ordering by checking the hash chain values. In some implementations, it is possible for two or more operations to be distributed concurrently, such that multiple operations follow the same precedent operation. In some implementations, the collaboration client 230 defer to the global sequencing numbers assigned by the collaboration platform 287 to impose an ordering on concurrent operations. In the event that the collaboration platform 287 equivocates, such that different clients arrive at different orderings, the hash chain values for later operations will diverge. Accordingly, such equivocation will be detected. In some implementations, priority between concurrent operations is determined based on source identifier, where every collaboration client 230 is configured to prioritize between source identifiers in the same manner. Accordingly, every collaboration client 230 will determine the same ordering of the operation sequence.

At stage 430, the collaboration client 230 constructs a client view of the access controls for the document from the operation data. In some implementations, the collaboration client 230 locates all sharing operations modifying the access control data for the document and constructs a current view of the access control data. As shown in FIG. 3C, the current view of the access control data includes an encrypted copy of a document-specific asymmetric decryption key for reading the initial operations creating the document, where the encrypted copy is encrypted using the user's specific encryption key and included in the user's reader authorization tuple 388. Older content modifying operations may have been encrypted with older keys, which are now expired. However, the current view of the access control data includes an encrypted set of expired document decryption keys 398. Accordingly, if the user has read permissions, the user has access to all necessary document decryption keys. In some implementations, the document is not encrypted and all users have read permissions. In some implementations, all document content updates are encrypted and a user must have read permissions in order to decrypt and view the document content updates. In some implementations, operations modifying authorization tuples 380 are encrypted with the document encryption key 393, except sharing operations granting a user read permissions or changing a user's read authorization tuple 388, which are left unencrypted. In some implementations where some operations modifying authorization tuples 380 are encrypted, the collaboration client 230 performs multiple passes through the operation sequence, including a first pass to obtain document decryption keys and a second pass to decrypt authorization operations and build a view of document access data.

At stage 434, the collaboration client 230 authenticates and validates each sharing operation in the sequence of operations. In some implementations, operations are authenticated prior to validating authorization. In some implementations, operations are validated as authorized prior to authenticating.

The collaboration client 230 steps through the sequence of operations and locates an earliest sharing operation. The earliest sharing operation is authenticated using root of trust data 325. In some implementations, the collaboration client 230 has, as a root of trust 325, an authenticated copy of the document originator's public signature verification key. The collaboration client 230 authenticates the earliest sharing operation by verifying that the earliest sharing operation has a valid signature from the document originator, based on the root of trust 325. In some implementations, the collaboration client 230 proceeds from the earliest sharing operation through subsequent sharing operations until it reaches a sharing operation granting the local user account read permissions. In such an implementation, the collaboration client 230 continues to update the access control data as it proceeds through constructing a client view of the document content in stage 440. In some implementations, the collaboration client 230 proceeds from the earliest sharing operation through subsequent sharing operations until it has exhausted all operations. In such an implementation, the collaboration client 230 has a current view of authorizations prior to constructing a client view of the document content in stage 440.

Each sharing operation includes a respective source signature. The collaboration client 230 authenticates each sharing operation by validating the source signature. Each collaborator authorized to share the document, or to update the access control data, has an administration authorization tuple 382 in the access control data. The administration authorization tuple 382 includes a signature verification key for the corresponding administrative user. Accordingly, the collaboration client 230 uses the signature verification key corresponding to the source identifier for each sharing operation and authenticates whether the sharing operation is properly signed by the purported source.

The collaboration client 230 validates that each sharing operation is authorized by verifying that the source identifier had authorization to make the change specified by the sharing operation. Each collaborator authorized to update the access control data has an administration authorization tuple 382 in the access control data. The administration authorization tuple 382 includes specific permissions for the corresponding administrative user. Accordingly, the collaboration client 230 uses the specific permissions corresponding to the source identifier for each sharing operation and validates whether the sharing operation is permitted to be performed by the purported source.

If a sharing operation is not valid or not authorized, the collaboration client 230 rejects the sharing operation. In some implementations, the collaboration client 230 notifies one or more users that the document data is corrupt.

If a sharing operation is valid and authorized, the collaboration client 230, then, at stage 436, applies the sharing operation to the access control data for the document. The operation can, for example, add new users by adding new authorization tuples 380. The operation can, for example, modify specific user permissions by modifying authorization tuples 380. The operation can, for example, revoke user permissions by removing a corresponding authorization tuple 380. When an operation revokes user permissions, the document encryption key 393 may need to be replaced. Accordingly, the sharing operation may update the document keys 390. Because each operation is cryptographically signed, authenticated, and validated as authorized based on prior sharing data, there is a natural chain of trust back to an initial sharing operation. The initial sharing operation is authenticated based on the root of trust data 325. Accordingly, the authenticity and reliability of the access control data is maintained in view of the root of trust data 325.

At stage 440, the collaboration client 230 constructs a client view of the document content for the document from the operation data. The collaboration client 230 begins with an earliest document content operation, which establishes a new document and may populate the document with initial content. If the document is encrypted, the operation is encrypted with a document-specific asymmetric encryption key. However, if the user has proper read permissions in the access control data, as discussed above, then the collaboration client 230 has access to the proper decryption key. The collaboration client 230 decrypts any encrypted operations using the proper decryption key.

At stage 444, the collaboration client 230 authenticates and validates each editing operation in the sequence of operations. In some implementations, operations are authenticated prior to validating authorization. In some implementations, operations are validated as authorized prior to authenticating.

Each editing operation includes a respective source signature. The collaboration client 230 authenticates each editing operation by validating the source signature. Each collaborator authorized to edit the document has a writer authorization tuple 384 in the access control data. The writer authorization tuple 384 includes a signature verification key for the corresponding editing user. Accordingly, the collaboration client 230 uses the signature verification key corresponding to the source identifier for each editing operation and authenticates whether the editing operation is properly signed by the purported source.

The collaboration client 230 validates that each editing operation is authorized by verifying that the source identifier had authorization to make the change specified by the editing operation. Each collaborator authorized to update the access control data has an administration authorization tuple 382 in the access control data. The administration authorization tuple 382 includes specific permissions for the corresponding administrative user. Accordingly, the collaboration client 230 uses the specific permissions corresponding to the source identifier for each sharing operation and validates whether the sharing operation is permitted to be performed by the purported source.

If an editing operation is not valid or not authorized, the collaboration client 230 rejects the editing operation. In some implementations, the collaboration client 230 notifies one or more users that the document data is corrupt.

If an editing operation is valid and authorized, the collaboration client 230, then, at stage 446, applies the editing operation to initial content for the document. The operation content adds to, removes from, or otherwise modifies the document content. The result of applying all of the operations, in order, is a reconstructed representation of the document content. Because all clients follow the same sequence of operations in the same order, all collaboration clients 230 arrive at the same reconstructed representation of the document content.

At stage 470, the collaboration client 230 provides the constructed document to the document editor application 226. In some implementations, the collaboration client 230 writes the document content to a temporary file and directs the document editor application 226 to access the temporary file. In some implementations, the collaboration client 230 provides the document content directly to the document editor application 226. For example, in some implementations, the collaboration client 230 includes a file system filter, and responds to a file system call with the document content. In some implementations, the document editor application 226 has an API through which the collaboration client 230 provides the constructed document content.

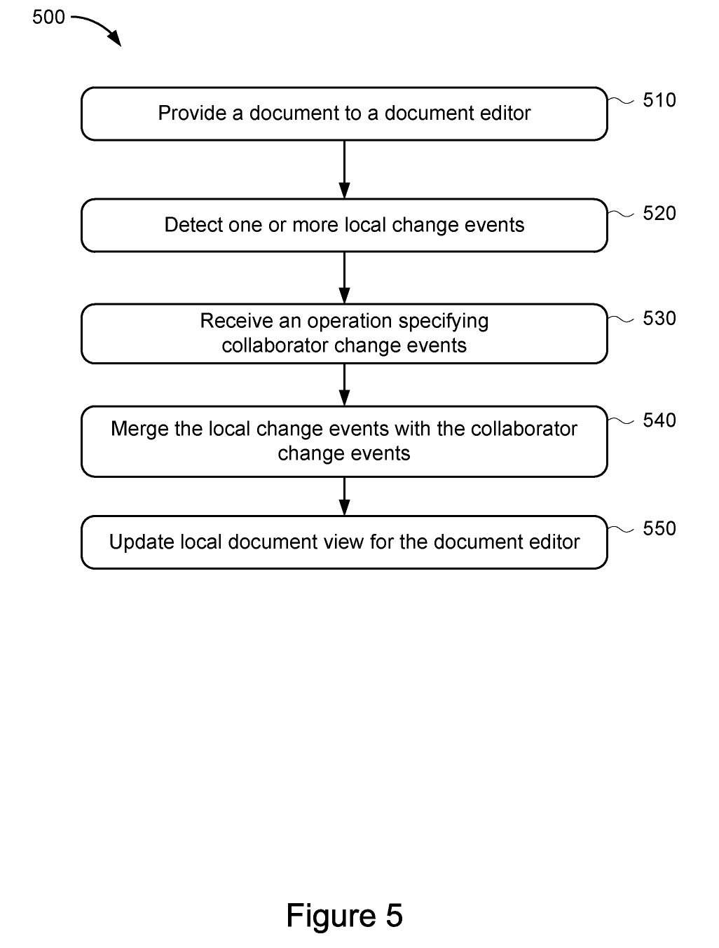

FIG. 5 is a flowchart for a method 500 of merging operations. While a user is viewing and/or modifying a document, collaborators may distribute modifications to the document. In broad overview of the method 500, at stage 510, a collaborative client 230 provides a document to a document editor 226. For example, the collaborative client 230 may use the method 400 presented above. At stage 520, the collaborative client 230 detects one or more local change events. At stage 530, the collaborative client 230 receives an operation specifying collaborator change events. At stage 540, the collaborative client 230 merges the one or more local change events with the collaborator change events. The collaborative client 230 updates the local view of the document content and, at stage 550, provides the updated local view of the collaborative document to the document editor 226.

Referring to FIG. 5 in more detail, at stage 510, a collaborative client 230 provides a document to a document editor 226. For example, the collaborative client 230 may use the method 400 presented above. While the document editor 226 is presenting the document to a user, the collaborative client 230 detects one or more local change events. In some implementations, the collaborative client 230 is notified by the document editor 226 of the changes. In some implementations, the collaborative client 230 monitors the document editor 226 and detects changes. For example, in some implementations, the document editor 226 provides an API through which the collaborative client 230 can obtain a view of the current document content. In some implementations, the collaborative client 230 maintains a shadow view of the document content and periodically compares the shadow view to a current view pulled from the document editor 226 via the API. In some implementations, the collaborative client 230 waits for the document editor 226 to attempt to save the document and hooks the file system call writing the document.

At stage 530, the collaborative client 230 receives an operation specifying collaborator change events. In some implementations, the collaborative client 230 periodically polls a collaboration platform 287 for new operations. In some implementations, the collaboration platform 287 notifies the collaboration client 230 when new operations are posted. When the collaborative client 230 detects a new operation, or when the collaborative client 230 is alerted to a new operation, the collaborative client 230 downloads the operation data from the collaboration platform 287 and unpacks it. In some implementations, the collaborative client 230 authenticates the operation signature and verifies that the source of the operation is authorized to perform the operation, based on the access control data for the document.

At stage 540, the collaborative client 230 merges the one or more local change events with the collaborator change events. If the local document is unchanged, the collaborative client 230 simply applies the operation to the local view of the document. If, however, the local view of the document has been modified, then the collaborative client 230 transforms the new operation to account for these changes. Operational transforms are generally content-type specific.

The collaborative client 230 updates the local view of the document content and, at stage 550, provides the updated local view of the collaborative document to the document editor 226. To update the local view, the transformed operation from stage 540 is applied to the local view. The collaboration client 230 then causes the document editor 226 to update the document content with the new version of the document content. In some implementations, the document editor 226 provides an API for updating the document content. In some implementations, the document editor 226 is forced to refresh presentation of the content. In the event that the content merge from stage 540 is imperfect, the local user can then correct any errors in the content.

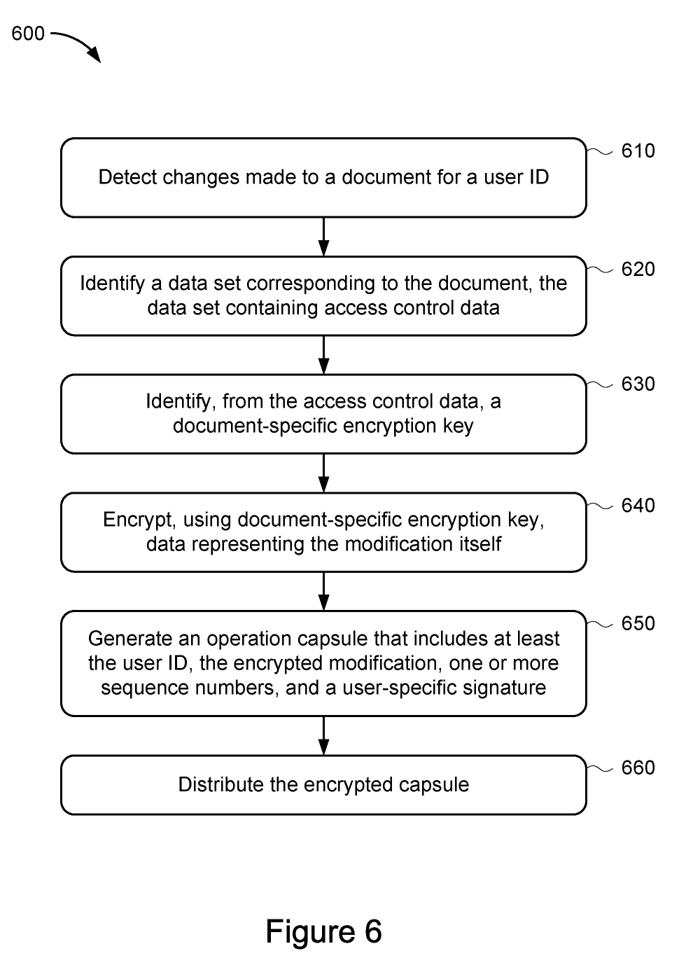

FIG. 6 is a flowchart for a method 600 of propagating a modification among collaborators. In broad overview, at stage 610, the collaboration client 230 detects a document editor attempt to modify a document for a user identifier. At stage 620, the collaboration client 230 identifies a data set 300 corresponding to the document. The data set 300 includes access control data 360. At stage 630, the collaboration client 230 identifies, from the access control data 360, a document-specific encryption key 393. At stage 640, the collaboration client 230 uses the document-specific encryption key 393 to encrypt data representing the modification. At stage 650, the collaboration client 230 generates an operation capsule that includes at least the user identifier, the encrypted modification, one or more sequence numbers, and a user-specific signature. At stage 660, the collaboration client 230 distributes the encrypted capsule.

Referring to FIG. 6 in more detail, at stage 610, the collaboration client 230 detects a document editor attempt to modify a document for a user identifier. In some implementations, the collaboration client 230 detects the modification via an application add-in, e.g., as shown in FIG. 2B. In some implementations, the collaboration client 230 polls the document editor at regular intervals looking for changes to the document. A change event begins when the document is first altered and ends when the document has not been further altered for at least a threshold length of time, that is, until there is a lull of at least a threshold length. In some implementations, the collaboration client 230 polls the document every second. In some implementations, the collaboration client 230 detects the end of the change event after a lull of at least 3 seconds. In some implementations, the collaboration client 230 is associated with a particular user identifier. For example, in some implementations, the user activates or logs in to the collaboration client 230.

At stage 620, the collaboration client 230 identifies a data set 300 corresponding to the document. The data set 300 includes access control data 360.

At stage 630, the collaboration client 230 identifies, from the access control data 360, a document-specific encryption key 393. In some implementations, the document-specific public encryption key 393 is available without needing a decryption key. In some implementations, sharing operations are not encrypted. Accordingly, keys included in the access control modifications represented by sharing operations are likewise not encrypted.

At stage 640, the collaboration client 230 uses the document-specific encryption key 393 to encrypt data representing the modification. The document-specific encryption key 393 is an asymmetric key for use in an asymmetric encryption scheme such as RSA. When the collaboration client 230 encrypts the modification information using the document-specific encryption key 393, only parties with the corresponding document-specific decryption key can use the modification data. The corresponding document-specific decryption key is included in the sharing operations, but always encrypted with encryption keys corresponding to users with read authorization. In some implementations, the document is not encrypted and all users have read authorization.

At stage 650, the collaboration client 230 generates an operation capsule that includes at least the user identifier, the encrypted modification, one or more sequence numbers, and a user-specific signature. These capsules are operations 344. In some implementations, the one or more sequence numbers include a local operation count. In some implementations, the one or more sequence numbers include a hash chain value.

At stage 660, the collaboration client 230 distributes the encrypted capsule. In some implementations, the collaboration client 230 uploads the encrypted capsule to a collaboration platform 287 via the network 110. In some implementations, the collaboration platform 287 assigns the capsule a global sequence identifier, which travels with the capsule unencrypted. The collaboration platform 287 then provides the capsule to the other clients 230. In some implementations, each collaboration client 230 polls the collaboration platform 287 for new encrypted capsules at regular intervals and fetches new encrypted capsules as they become available. In some implementations, the collaboration platform 287 pushes new encrypted capsules to the collaboration clients 230. In some implementations, the collaboration platform 287 only accepts the capsule if the collaboration client 230 is up to date. That is, the collaboration client 230 may be required to download all pending updates prior to uploading a capsule.

A receiving collaboration client then decrypts the capsule and authenticates the operation data represented therein. The receiving collaboration client then applies the modification to the local copy.

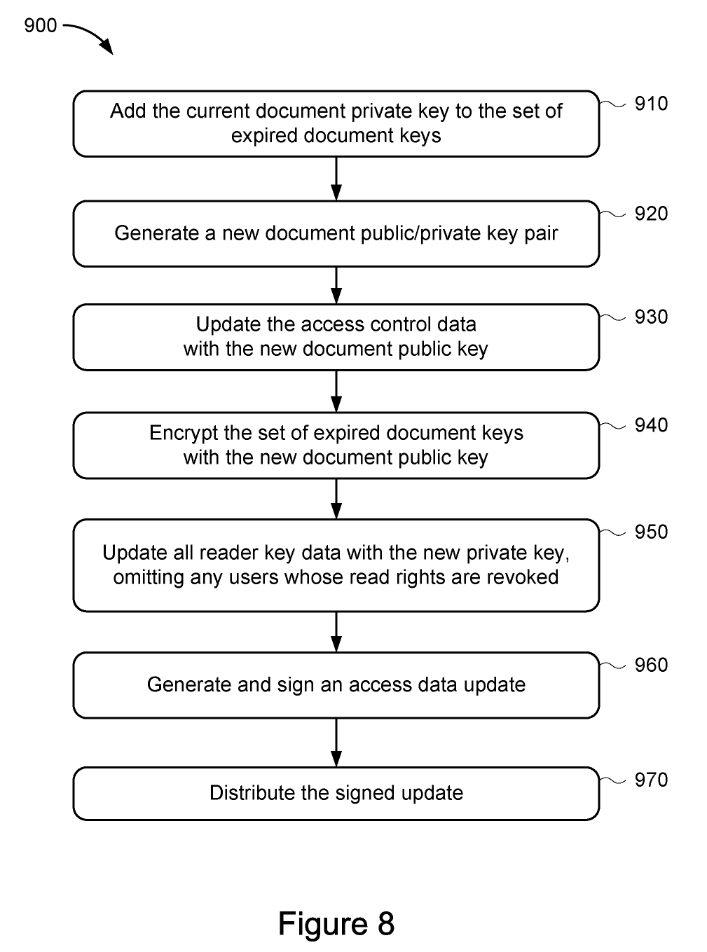

These same strategies may be used to update the access control data. Any modifications to access control data, e.g., modifications to read, write, or administrative authorizations, are operations. For example, to share the document with a new reading user, an operation inserts a new reader authorization tuple 388. As another example, to share the document with a new writing user, an operation inserts a new writer authorization tuple 384. In this example, if the new writing user does not have read authorization, then the user only has write authorization. Read authorization and write authorization are separable. Generally, operations modifying access controls are signed by users with administrator authorizations in the access control data 360 and collaboration clients 230 will only accept an access control operation if the operation is authorized in the access control data 360 prior to the operation. If a user with document administrator permissions changes his or her own signature key pair, the operation updating the user's administrator authorization tuple 382 is signed with the user's old signing key so that it can be validated with the old signature verification key. If a user's read permissions are revoked, the document keys 390 are updated as well. The method 900, shown in FIG. 8 and described in detail below, is a is a flowchart for a method of revoking reader permissions.

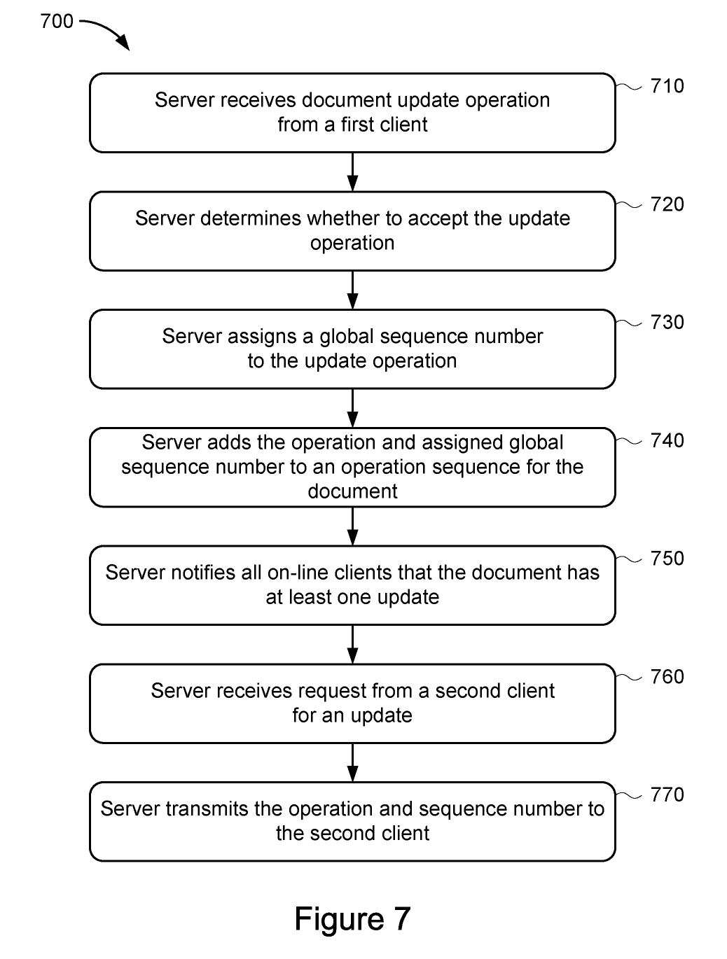

FIG. 7 is a flowchart for a method 700 of receiving and distributing operation data. In broad overview, at stage 710, a server receives a document update operation from a first client. At stage 720, the server determines whether to accept the update operation. At stage 730, the server assigns a global sequence number to the update operation. At stage 740, the server adds the operation and assigned global sequence number to an operation sequence for the corresponding document. At stage 750, the server notifies all on-line clients that the document has at least one update. At stage 760, the server receives a request from a second client for an update and, at stage 770, the server transmits the operation and sequence number to the second client.

Referring to FIG. 7 in more detail, at stage 710, a server receives a document update operation from a first client. In some implementations, the server is a collaboration platform 287. In some implementations, the collaboration platform 287 is implemented on a single host device 140. In some implementations, the collaboration platform 287 is distributed over a plurality of host devices 140. In some implementations, multiple instances of the collaboration platform 287 operate in concert, sharing access to data resources 160. The collaboration platform 287 receives operation data from collaboration clients 230.

At stage 720, the server determines whether to accept the update operation. In some implementations, the collaboration clients 230 log-in to the collaboration platform 287, e.g., using access credentials associated with a user. In some implementations, documents are identified by a uniform resource locator (“URL”). In some implementations, the collaboration platform 287 accepts document updates from anyone with the correct identifier for the document. In some implementations, the collaboration platform 287 only accepts operation updates if the request is associated with a user identifier affiliated with the document. In some implementations, the access control data for a document is unencrypted. Accordingly, the collaboration platform can process the update operations and maintain a list of user identifiers named in the access control data. In some implementations, the collaboration platform only accepts operation submissions affiliated with user identifiers named in the access control data. In some implementations, the collaboration platform only accepts operation submissions affiliated with user identifiers with write permissions or administrative permissions specified in the access control data. In some implementations, the collaboration platform 287 requires the collaboration client 230 to be updated with all pending document updates prior to submitting a new document update operation. In some implementations, when a collaboration client 287 submits an update operation, the collaboration client 287 identifies the last received operation update. If the collaboration platform 287 has additional updates, the upload is denied and the collaboration client is required to download the additional updates.

At stage 730, the server assigns a global sequence number to the update operation. Once the collaboration platform has determined to accept the update operation, it assign a global sequencing number. In some implementations, the global sequencing number is incremental. In some implementations, the global sequencing number is a count of operations received for the corresponding document. In some implementations, the global sequencing number is a time stamp.

At stage 740, the server adds the operation and assigned global sequence number to an operation sequence for the corresponding document. The collaboration platform 287 saves the received document update to the storage resource 160. In some implementations, the storage resource 160 operates a database and each operation is entered into the database as an entry.

At stage 750, the server notifies all on-line clients that the document has at least one update. In some implementations, collaboration clients 230 periodically poll the collaboration platform to determine if new updates are available. In some implementations, collaboration clients 230 keep a communication channel open to the collaboration platform 287 and the collaboration platform 287 notifies the collaboration clients 230 when new updates are available. In some such implementations, the collaboration clients 230 registers with the collaboration platform 287 to receive updates for specifically identified documents.

At stage 760, the server receives a request from a second client for an update. In some implementations, the collaboration clients 230 submit requests for the update data. In some implementations, each update is assigned a uniform resource locator (“URL”) and the updates are requested using either a file transfer protocol (“FTP”) or hypertext transfer protocol (“HTTP”) request. In some implementations files are requested using secure file transfer protocol (“SFTP”) or hypertext transfer protocol secure (“HTTPS”). In some implementations, the request identifies a user identifier associated with the document.

At stage 770, the server transmits the operation and sequence number to the second client. Responsive to a request for specific update data, the collaboration platform 287 transmits the requested data. A collaboration client 230 requests operation data at stage 760 and the collaboration platform 287 responds to the request with the data requested. In some implementations, the collaboration platform 287 only responds if the request is associated with a user identifier affiliated with the document. In some implementations, the access control data for a document is unencrypted. Accordingly, the collaboration platform can process the update operations and maintain a list of user identifiers named in the access control data. In some implementations, the collaboration platform only accepts requests affiliated with user identifiers named in the access control data. In some implementations, the collaboration platform accepts requests from anyone with the correct document identifier.

FIG. 8 is a flowchart for a method 900 of revoking reader permissions. In broad overview, at stage 910, the collaboration client 230 adds the current document private key to the set of expired document private keys 398. At stage 920, the collaboration client 230 generates a new document (public/private) encryption/decryption key pair and, at stage 930, updates the access control data 360 with the new document encryption key 393. At stage 940, the collaboration client 230 encrypts the set of expired document keys with the new document public key. At stage 950, the collaboration client 230 updates all of the reader tuples 388 with respectively encrypted copies of the new private key, omitting any users whose read rights are revoked. At stage 960, the collaboration client 230 generates and signs an access data update. Then, at stage 970, the collaboration client 230 distributes the signed update.

Referring to FIG. 8 in more detail, at stage 910, the collaboration client 230 adds the current document decryption key to the set of expired document decryption keys 398.

In some implementations, the set of expired document decryption keys 398 is a list or vector of all previously used document decryption keys. In some implementations, each expired document decryption key in the list or vector is encrypted with the next-in-time document encryption key. That is, to decrypt a particular expired document decryption key, the collaboration client 230 needs the decryption key that replaced it. In some implementations, the set of expired document decryption keys 398 is a data structure indexing each expired document decryption key to a set of operations encrypted using the corresponding document encryption key.

At stage 920, the collaboration client 230 generates a new document (public/private) encryption/decryption key pair. The collaboration client 230 generates the key pair in accordance with the asymmetric encryption scheme in use. One key becomes the new document encryption key and the other becomes the new document decryption key.

At stage 930, updates the access control data 360 with the new document encryption key 393. The collaboration client 230 discards the old document encryption key by the end of the method 900, as it is no longer needed.

At stage 940, the collaboration client 230 encrypts the set of expired document keys with the new document public key. In some implementations, the set of expired document decryption keys 398 is encrypted once, with the new document encryption key, such that all of the old decryption keys are readily available with the new document decryption key. Each expired document decryption key corresponds to a respective expired document encryption key that can be discarded. In some implementations, each document decryption key is encrypted using the specific encryption key replacing the corresponding expired document encryption key. In such an implementation, only the current document decryption key being expired needs to be encrypted with the new document encryption key.

At stage 950, the collaboration client 230 updates all of the reader tuples 388 with respectively encrypted copies of the new private key, omitting any users whose read rights are revoked. The collaboration client 230 deletes from the client's local view of access data 360 the reader authorization tuples 388 for users whose read rights are revoked. In some implementations, a user is authorized to replace a user's (e.g., his or her own) keys. In some such implementations, the user's read keys are modified with a new encryption key. That is, the user's reader authorization tuple 388 is replaced with a new tuple specifying a new encryption key. In some implementations, the user's administrator authorization tuple 382 and writer authorization tuple 384 are similarly updated with new signature verification keys. In some implementations, when a user's read key is updated with a new encryption key, the document keys are changed as well.

At stage 960, the collaboration client 230 generates and signs an access data update. The access data update packages instructions for collaborators to use in updating the access control data 360 so that all collaborators agree on who has access permissions. The access update is signed with the user's private key corresponding to the public key specified in the user's administrator authorization tuple 382. Collaborators will only accept the access update if the signature can be validated and the user has the proper authorization. If the update changes the signature verification key for the source of the update, the it is signed using the user's old signature key so that it can be verified using the user's old signature verification key.

At stage 970, the collaboration client 230 distributes the signed update. The collaboration client 230 uploads the update to the collaboration platform 287. This process is the same for uploading any modification to the collaborative document.

Additional operations are enabled by these systems and methods. For example, a user can have a limited write permission without having a read permission. Accordingly, the user could add data to a collaborative document without being able to read other collaborator contributions. This may be useful, for example, in maintaining a collaborative activity log.

In some implementations, a messaging system is created using collaborative documents. A user creates a document and grants himself read permissions. The user then shares the document with collaborators, granting the collaborators append-only permissions. Any of the user's collaborators can then write messages to the document, but no one can read them except the user. In some implementations, the user grants global append permissions for the document so that anyone with access to the document can append to it. The document become a secure inbox for receiving messages that only the user can read. In some implementations, a secure inbox is used for distributing asymmetric keys, e.g., signature verification keys. In some implementations, when a user shares a new collaborative document with collaborators, the collaboration client 230 sends the collaborators a message through the secure inbox, the message including the document's root of trust, e.g., the original author's signature verification key, and a secure link to the document. Accordingly, users can securely share a document without needing to first distribute document keys.

A secure mode of messaging further enables anonymous collaboration. A user wishing to share a collaborative document with a party who should remain anonymous to the user's other collaborators can create a fictional “straw” user account. The user creates public/private keys for the straw account and shares the document with the straw account. The user grants the straw account permission to replace its own keys. The user then sends, to the party who should remain anonymous, a message that includes the account information for the straw account. The account information includes the private keys for the straw account. The anonymous party then replaces the keys with new ones, such that the anonymous party is in sole possession of the private keys. At this point, only the original user and the anonymous party know the identity of the anonymous party; the other collaborators remain in the dark. In some implementations, the user only grants the anonymous party read permissions, e.g., so that the anonymous party may monitor the state of the document. In some implementations, a document's original author shares the document with multiple anonymous collaborators in this manner. Each anonymous user is anonymous to the others. As with any other user, an anonymous user can be granted write permissions and/or administrative permissions. The permissions can be specific, e.g., allowing a particular user to only edit certain pages. In some implementations, the initial user grants the straw account full administrative permissions and then revokes his or her own permissions. The document then belongs solely to the anonymous user.

A combination of anonymous collaboration and secure messaging may be used to facilitate secure anonymous messaging.

In some implementations, document collaboration permissions are managed for a group of users. A user creates a fictional “straw” user account to represent the user group. The user grants a group access to a substantive document, e.g., document administration, editing, or reading authorizations, by granting the appropriate authorizations to the straw account. In some implementations, members are added to the group by giving the members access to the straw account information, e.g., in the same manner discussed above for anonymous collaboration. In some implementations, additional data structures define who is in a particular group. For example, in some implementations, a collaborative document (a “group access” document) contains the information for accessing the straw account information. A user is admitted into the group by granting the user read permission on the group access document, and removed from the group by revoking read permission on the group access document. The group access document includes the straw account's information for accessing the substantive document. Accordingly, when a group member is removed, the straw account's keys are updated and the old document keys for the substantive document are expired. In some implementations, when a member of the group modifies the substantive document, the modification is signed using a signature key associated with the straw account for the group. In some implementations, the group member further signs the modification, or the signature of the modification, with his or her own signature key. The additional signature of the group member is used to attribute the modification to a particular group member. In some implementations, the collaboration client 230 is configured to parse the group access document and read, from the group access document, the signature verification keys for the group's members. Such a collaboration client 230 can then verify that the group member's signature is correct. In some implementations, the collaboration client 230 further verifies that the group access document has not be modified since the group member signed a substantive modification. That is, the collaborative client 230 verifies that the group member is still a group member at the time of the modification.

FIG. 9 is a block diagram illustrating a general architecture of a computing system 101 suitable for use in some implementations described herein The example computing system 101 includes one or more processors 107 in communication, via a bus 105, with one or more network interfaces 111 (in communication with a network 110), I/O interfaces 102 (for interacting with a user or administrator), and memory 106. The processor 107 incorporates, or is directly connected to, additional cache memory 109. In some uses, additional components are in communication with the computing system 101 via a peripheral interface 103. In some uses, such as in a server context, there is no I/O interface 102 or the I/O interface 102 is not used. In some uses, the I/0 interface 102 supports an input device 104 and/or an output device 108. In some uses, the input device 104 and the output device 108 use the same hardware, for example, as in a touch screen. In some uses, the computing device 101 is stand-alone and does not interact with a network 110 and might not have a network interface 111.

In some implementations, one or more computing systems described herein are constructed to be similar to the computing system 101 of FIG. 9. For example, a user may interact with an input device 104, e.g., a keyboard, mouse, or touch screen, to access an application or obtain data via the network 110. The interaction is received at the user's device's interface 102, and responses are output via output device 108, e.g., a display, screen, touch screen, or speakers.

In some implementations, one or more devices are constructed to be similar to the computing system 101 of FIG. 9. In some implementations, a server may be a virtual server, for example, a cloud-based server accessible via the network 110. A cloud-based server may be hosted by a third-party cloud service host. A server may be made up of multiple computer systems 101 sharing a location or distributed across multiple locations. The multiple computer systems 101 forming a server may communicate using the user-accessible network 110. The multiple computer systems 101 forming a server may communicate using a private network, e.g., a network distinct from a publicly-accessible network or a virtual private network within a publicly-accessible network.

The processor 107 may be any logic circuitry that processes instructions, e.g., instructions fetched from the memory 106 or cache 109. In many implementations, the processor 107 is a microprocessor unit. The processor 107 may be any processor capable of operating as described herein. The processor 107 may be a single core or multi-core processor. The processor 107 may be multiple processors.

The I/O interface 102 may support a wide variety of devices. Examples of an input device 104 include a keyboard, mouse, touch or track pad, trackball, microphone, touch screen, or drawing tablet. Example of an output device 108 include a video display, touch screen, speaker, inkjet printer, laser printer, or 3D printer. In some implementations, an input device 104 and/or output device 108 may function as a peripheral device connected via a peripheral interface 103.

A peripheral interface 103 supports connection of additional peripheral devices to the computing system 101. The peripheral devices may be connected physically, as in a universal serial bus (“USB”) device, or wirelessly, as in a BLUETOOTH™ device. Examples of peripherals include keyboards, pointing devices, display devices, audio devices, hubs, printers, media reading devices, storage devices, hardware accelerators, sound processors, graphics processors, antennas, signal receivers, measurement devices, and data conversion devices. In some uses, peripherals include a network interface and connect with the computing system 101 via the network 110 and the network interface 111. For example, a printing device may be a network accessible printer.

The network 110 is any network, e.g., as shown and described above in reference to FIG. 1. Examples of networks include a local area network (“LAN”), a wide area network (“WAN”), an inter-network (e.g., the Internet), and peer-to-peer networks (e.g., ad hoc peer-to-peer networks). The network 110 may be composed of multiple connected sub-networks and/or autonomous systems. Any type and/or form of data network and/or communication network can be used for the network 110.

The memory 106 may each be implemented using one or more data storage devices. The data storage devices may be any memory device suitable for storing computer readable data. The data storage devices may be a device with fixed storage or a device for reading removable storage media. Examples include all forms of non-volatile memory, media and memory devices, semiconductor memory devices (e.g., EPROM, EEPROM, SDRAM, and flash memory devices), magnetic disks, magneto optical disks, and optical discs (e.g., CD ROM, DVD-ROM, or BLU-RAY discs). Example implementations of suitable data storage devices include storage area networks (“SAN”), network attached storage (“NAS”), and redundant storage arrays.

The cache 109 is a form of data storage device place on the same circuit strata as the processor 107 or in close proximity thereto. In some implementations, the cache 109 is a semiconductor memory device. The cache 109 may be include multiple layers of cache, e.g., L1, L2, and L3, where the first layer is closest to the processor 107 (e.g., on chip), and each subsequent layer is slightly further removed. Generally, cache 109 is a high speed low latency memory.

The computing system 101 can be any workstation, desktop computer, laptop or notebook computer, server, handheld computer, mobile telephone or other portable tele-communication device, media playing device, a gaming system, mobile computing device, or any other type and/or form of computing, telecommunications or media device that is capable of communication and that has sufficient processor power and memory capacity to perform the operations described herein.

It should be understood that the systems and methods described above may be provided as instructions in one or more computer programs recorded on or in one or more articles of manufacture, e.g., computer-readable media. The article of manufacture may be a floppy disk, a hard disk, a CD-ROM, a flash memory card, a PROM, a RAM, a ROM, or a magnetic tape. In general, the computer programs may be implemented in any programming language, such as LISP, Perl, C, C++, C#, Python, Ruby, PROLOG, or in any byte code language such as JAVA. The software programs may be stored on or in one or more articles of manufacture as object code. The article of manufacture stores this data in a non-transitory form.

While this specification contains many specific implementation details, these descriptions are of features specific to various particular implementations and should not be construed as limiting. Certain features described in the context of separate implementations can also be implemented in a unified combination. Additionally, many features described in the context of a single implementation can also be implemented separately or in various sub-combinations. Similarly, while operations are depicted in the figures in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all implementations, and it should be understood that the described program components and systems can generally be integrated in a single software product or packaged into multiple software products.

References to “or” may be construed as inclusive so that any terms described using “or” may indicate any of a single, more than one, and all of the described terms. Likewise, references to “and/or” may be construed as an explicit use of the inclusive “or.” The labels “first,” “second,” “third,” an so forth are not necessarily meant to indicate an ordering and are generally used merely as labels to distinguish between like or similar items or elements.

Having described certain implementations and embodiments of methods and systems, it will now become apparent to one of skill in the art that other embodiments incorporating the concepts of the disclosure may be used. Therefore, the disclosure should not be limited to certain implementations or embodiments, but rather should be limited only by the spirit and scope of the following claims.

What is claimed is:

1. A non-transitory computer-readable medium storing instructions that, when executed by a computing processor, cause the computing processor to:
detect, for an electronic document, a change event associated with a user identifier;
identify, for the electronic document, a document-specific asymmetric encryption key;
identify, for the user identifier, a user-specific signature key;
generate a digital representation of the change event containing at least a context identifier for a state of the electronic document prior to the change event and an instruction for effecting the change event;
generate, using the user-specific signature key, a cryptographic signature of the digital representation of the change event; and
generate an operation capsule containing at least the digital representation of the change event and the cryptographic signature.

2. The non-transitory computer-readable medium of claim 1, further storing instructions that, when executed by the computing processor, cause the computing processor to transmit the operation capsule to a remote server.

3. The non-transitory computer-readable medium of claim 1, wherein the change event is a modification to authorization data for the electronic document.

4. The non-transitory computer-readable medium of claim 1, further storing instructions that, when executed by the computing processor, cause the computing processor to:
verify, in a set of permissions associated with the electronic document, that the user identifier has authorization to perform the change event.

5. The non-transitory computer-readable medium of claim 1, further storing instructions that, when executed by the computing processor, cause the computing processor to:
include, in the operation capsule, the user identifier and one or more sequence numbers.

6. The non-transitory computer-readable medium of claim 1, further storing instructions that, when executed by the computing processor, cause the computing processor to:
receive, for the electronic document, a collaborator operation capsule containing at least a collaborator identifier, a digital representation of a collaborator change event, and a collaborator signature for the digital representation of the collaborator change event;
authenticate the collaborator signature using a collaborator-specific signature verification key;
verify, in a set of permissions associated with the electronic document, that the collaborator identifier has authorization to perform the collaborator change event; and
apply the change event to the electronic document.

7. The non-transitory computer-readable medium of claim 6, further storing instructions that, when executed by the computing processor, cause the computing processor to:
identify, for the electronic document, a document-specific asymmetric decryption key;
decrypt the digital representation of the collaborator change event using the document-specific asymmetric decryption key.

8. The non-transitory computer-readable medium of claim 7, further storing instructions that, when executed by the computing processor, cause the computing processor to:
identify a user-specific read authorization containing at least an encrypted copy of the document-specific asymmetric decryption key, the encrypted copy encrypted using a user-specific asymmetric encryption key; and
decrypt the encrypted copy of the document-specific asymmetric decryption key using a user-specific asymmetric decryption key.

9. The non-transitory computer-readable medium of claim 1, further storing instructions that, when executed by the computing processor, cause the computing processor to detect the change event by monitoring a document editing application executing on the computing processor.

10. A method comprising:
detecting, by a computer processor, for an electronic document, a change event associated with a user identifier;
identifying, for the electronic document, a document-specific asymmetric encryption key;
identifying, for the user identifier, a user-specific signature key;
generating, by the computer processor, a digital representation of the change event containing at least a context identifier for a state of the electronic document prior to the change event and an instruction for effecting the change event;
generating, using the user-specific signature key, a cryptographic signature of the digital representation of the change event;
encrypting, using the document-specific asymmetric encryption key, the digital representation of the change event; and
generating an operation capsule containing at least the encrypted digital representation of the change event and the cryptographic signature.

11. The method of claim 10, further comprising transmitting the operation capsule to a remote server.

12. The method of claim 10, wherein the change event is a modification to authorization data for the electronic document.

13. The method of claim 10, further comprising:
verifying, in a set of permissions associated with the electronic document, that the user identifier has authorization to perform the change event.

14. The method of claim 10, comprising including, in the operation capsule, the user identifier and one or more sequence numbers.

15. The method of claim 10, further comprising:
receiving, for the electronic document, a collaborator operation capsule containing at least a collaborator identifier, a digital representation of a collaborator change event, and a collaborator signature for the digital representation of the collaborator change event;
authenticating the collaborator signature using a collaborator-specific signature verification key;
verifying, in a set of permissions associated with the electronic document, that the collaborator identifier has authorization to perform the collaborator change event;
applying the change event to the electronic document.

16. The method of claim 15, further comprising:
identifying, for the electronic document, a document-specific asymmetric decryption key;
decrypting the digital representation of the collaborator change event using the document-specific asymmetric decryption key.

17. The method of claim 16, further comprising:
identifying a user-specific read authorization containing at least an encrypted copy of the document-specific asymmetric decryption key, the encrypted copy encrypted using a user-specific asymmetric encryption key; and
decrypting the encrypted copy of the document-specific asymmetric decryption key using a user-specific asymmetric decryption key.

18. A system comprising:
a memory storing a sequence of operation capsules for a document, each operation capsule containing at least a respective source identifier, a respective digital representation of a respective change event attributable to the respective source identifier, a respective cryptographic signature for the respective digital representation of the respective change event, and a respective sequence identifier, wherein at least one operation capsule in the sequence of operation capsules comprises an encrypted digital representation of its respective change event, the encrypted digital representation encrypted using a document-specific asymmetric encryption key; and
a processor configured to:
receive a new operation capsule for a document;
assign a new sequence identifier to the new operation capsule; and
add the new operation capsule, with the new sequence identifier, to the sequence of operation capsules for the document.

19. The system of claim 18, the processor further configured to notify, via a network, at least one client device of an availability of the new operation capsule.

20. The system of claim 18, the processor further configured to transmit, via a network, the new operation capsule to at least one client device.

21. A non-transitory computer-readable medium storing instructions that, when executed by a computing processor, cause the computing processor to:
generate, for an electronic document, a set of permissions associated with the electronic document by processing a sequence of access control modification events associated with the electronic document;
receive, for the electronic document, a collaborator operation capsule containing at least a collaborator identifier, a digital representation of a collaborator change event, and a collaborator signature for the digital representation of the collaborator change event;
authenticate the collaborator signature using a collaborator-specific signature verification key specified in the set of permissions associated with the electronic document;
verify that the collaborator identifier has an authorization specified within the set of permissions associated with the electronic document to perform the collaborator change event based on the electronic document and the digital representation of the collaborator change event; and
apply the change event to the electronic document.

22. The non-transitory computer-readable medium of claim 21, wherein the collaborator change event is an access control modification event.

23. The non-transitory computer-readable medium of claim 22, wherein the collaborator change event is a rights revocation event associated with the collaborator identifier.

24. The non-transitory computer-readable medium of claim 22, wherein verifying that the collaborator identifier has the authorization comprises identifying an authorization specified within the set of permissions associated with the electronic document, the authorization comprising a set of limitations, and verifying that the change event conforms to the set of limitations.

25. The non-transitory computer-readable medium of claim 24, wherein the set of limitations includes one or more of: only allowing append operations; only allowing new content additions; only allowing replacement of content previously added by an edit operation associated with the collaborator identifier; and only allowing key replacement for keys associated with the collaborator identifier.

26. A method comprising:
generating, for an electronic document, a set of permissions associated with the electronic document by processing a sequence of access control modification events associated with the electronic document;
receiving, for the electronic document, a collaborator operation capsule containing at least a collaborator identifier, a digital representation of a collaborator change event, and a collaborator signature for the digital representation of the collaborator change event;
authenticating the collaborator signature using a collaborator-specific signature verification key specified in the set of permissions associated with the electronic document;
verifying that the collaborator identifier has an authorization specified within the set of permissions associated with the electronic document to perform the collaborator change event based on the electronic document and the digital representation of the collaborator change event; and
applying the change event to the electronic document.

27. The method of claim 26, wherein the collaborator change event is an access control modification event.

28. The method of claim 27, wherein the collaborator change event is a rights revocation event associated with the collaborator identifier. Page 51

29. The method of claim 26, wherein verifying that the collaborator identifier has the authorization comprises identifying an authorization specified within the set of permissions associated with the electronic document, the authorization comprising a set of limitations, and verifying that the change event conforms to the set of limitations.

30. The method of claim 29, wherein the set of limitations includes one or more of: only allowing append operations; only allowing new content additions; only allowing replacement of content previously added by an edit operation associated with the collaborator identifier; and only allowing key replacement for keys associated with the collaborator identifier.
